(19) United States
(12) Patent Application Publication
(10) Pub. No.: US 2003/0220828 A1
(43) Pub. Date: Nov. 27, 2003

(54) Polymer production scheduling using transition models

(76) Inventors: Chih-An Hwang, Austin, TX (US); Kadir Liano, Austin, TX (US); Yong-Zai Lu, Coppell, TX (US); Willie Putrajaya, Austin, TX (US); Carl Schweiger, Round Rock, TX (US)

Correspondence Address: Jeffrey C. Hood, Meyertons, Hood, Kivlin, Kowert & Goetzel PC, P.O. Box 398, Austin, TX, 78767, US

(21) Appl. No.: 10/374,159

(22) Filed: Feb. 24, 2003

Related U.S. Application Data
(60) Provisional application No. 60/382,856, filed on May 23, 2002.

(51) Int. Cl. G06F 17/60

(52) U.S. Cl. 705/8; 700/197

(57) ABSTRACT

System and method for optimizing polymer production scheduling. The system includes an input, operable to receive optimization input information, a model of a polymer production system including one or more transition models representing transition behavior of the polymer production system, an optimizer, operable to execute the model using the received optimization input information to generate an optimized polymer production schedule, e.g., by solving an objective function subject to constraints, e.g., to minimize/maximize costs/profits and/or to minimize order times, and an output, operable to output the generated optimized polymer production schedule, wherein the optimized polymer production schedule is usable to manage polymer production with a polymer production system. In further embodiments, the system may include a controlled polymer production system and an advanced process control coupled to the controlled polymer production system, where the optimized polymer production schedule is usable to control the advanced process control for improved polymer production operations.

### PRIORITY CLAIM

This application claims benefit of priority of U.S. provisional application Serial No. 60/382,856 titled “Polymer Production Scheduling Using Transition Models” filed May 23, 2002, whose inventors are Chih-An Hwang, Kadir Liano, Yong-Zai Lu, Willie Putrajaya and Carl Schweiger.

### FIELD OF THE INVENTION

The present invention generally relates to the field of polymer product scheduling. More particularly, the present invention relates to systems and methods for optimizing polymer production scheduling using transition models.

### DESCRIPTION OF THE RELATED ART

Like any other commercial enterprise, those in the business of producing polymer desire to maximize efficiencies and profitability, while meeting customer demands. There are a number of issues germane to the problem of maximizing efficiencies and profitability for a polymer production process, including, for example, costs as functions of the business and manufacturing environments, e.g., production costs and rates, inventory costs, product sales prices, and capacity (resource) limits, among others. Polymer producing businesses must be able to produce polymer in a manner that allows for the consideration of these various issues. The ability to make produce polymer in such a manner may be further complicated for polymer plants producing more than one grade or type of polymer.

As shown in FIG. 1, a polymer plant 100 may produce polymers, including, for example, polyethylene (PE) and polypropylene (PP) among others, of varying grades. Different grades correspond to different molecular chain lengths, and may exhibit differences in properties such as hardness or flexibility. Different grades are therefore appropriate for manufacture of different products: For example, products such as car bumpers 112 may require hard-grade polymers, while items such as diapers 116 may require soft-grade polymers. Still other items such as milk bottles 114 may require polymers having yet another set of characteristics. Polymer product grades are usually defined in terms of the melt index (MI), melt flow rate (MFR) and the density of the product, among others. To meet customer demands, a polymer plant must be able to produce different grades of polymers.

A polymer plant 100 may employ one or more processing lines that are capable of transforming raw materials 110 into polymer products. One processing line may be capable of producing two or more different grades of polymers. A polymer of a particular grade (e.g., hard-grade) can be achieved by setting the processing line to a particular operating state that corresponds with that grade of polymer. To produce a polymer of a different grade (e.g., soft-grade), the state of the processing line must be changed to the operating state that corresponds with that different grade of polymer. A polymer plant may need to fulfill orders for both grades of polymer, and may need to produce both grades of polymer on the same processing line.

A processing line may be operated in “batch” mode, wherein the processing line produces polymers in batches, each batch being of a particular grade. In batch mode, the processing line operates in one state to produce a polymer of one grade, and then is taken “off-line” and reconfigured before being put back “on-line” to produce a subsequent batch of a different grade. A disadvantage of batch mode operation is the additional cost and time required to take the processing line off-line and to bring it back on-line. For example, it may take some period of time for the processing line to “warm-up” or stabilize after being brought back on-line.

Alternatively, a processing line may be operated in “continuous” mode, in which the processing line is continuously running and continuously producing product. As in batch mode, a processing line operating in continuous mode may be operated to first produce a polymer of one grade, and then be reset or reconfigured to then produce a polymer of a different grade. However, in continuous mode, the processing line is still operating and producing product while the line is being reset or reconfigured from one grade of polymer to another. During this transition time, the operating state of the processing line is changing, and thus the grade of the resulting polymer produced during the transition period is changing as well. The polymer produced during this transition time may not be usable or marketable, and therefore may be considered a “cost” of making the transition from a polymer of one grade to another.

Also, the time and cost required to achieve the transition from the production of one grade of polymer to a second grade of polymer may be greater that the time and cost required to transition to a third grade of polymer. For example, the transition from a soft-grade polymer to a hard-grade polymer may require more time and cost than a transition from a soft-grade polymer to a medium-grade polymer. Although continuous mode operation may avoid some of the costs and inefficiencies associated with batch mode operation, it introduces other costs and inefficiencies, such as those associated with the production of unusable polymers produced during the transition time.

A polymer plant 100 that receives customer orders for products requiring different grades of polymer must make decisions regarding the scheduling of the polymer production. Methods have been developed for the production scheduling of polymers having different grades. Two such prior art methods are the demand-focused and transition-focused methods described below. In both examples provided below, the polymer plant 100 has received customer orders for products A, B, C, D, E, F and G. The sequence of products in accordance with the date by which the customer has demanded delivery is A-G-E-C-F-B-D, with polymer product A having the earliest demanded delivery date. The sequence of product in accordance with the incremental change in transition time and/or costs is A-B-C-D-E-F-G, with the transition from A to B having the lowest associated time and/or cost as compared to the transitions from A to the other polymer products.

In the demand-focused method, the scheduling of polymer production is driven by demand, and the specifics of the manufacturing process, such as the cost and time required for transitions, are not considered. FIG. 2 is a graph illustrating an example of a polymer production schedule determined by the demand-focused approach according to prior-art. In this graph, the X axis represents the production schedule, and the Y axis represents the grade of the polymer being produced. As is seen in FIG. 2, the demand-focused production schedule sequences the polymers to be produced in accordance with the demanded delivery dates, regardless of the transitions required by such schedule. For example, the difference in the grades of polymer products A and G is the largest possible difference between any of the polymer products to be produced, and thus the transition between A and G may result in more time and cost than any transition between the other products. However, since polymer product G must be delivered before all others except A, polymer product G is scheduled produced immediately following the production of polymer product A.

Thus, a demand-focused scheduler is not concerned with the issues associated with transitioning from one polymer grade to another; it simply dictates that a particular product should be made.

In contrast, the transition-focused method schedules the production of polymer products in a manner intended to minimize the time and/or costs associated with transitions. This approach utilizes a transition matrix that indicates the cost and/or time of transition from one product to another. FIG. 3A shows an example of the transition table according to the prior art. The row and column headings represent the different grades (e.g., G_{—}001, G_{—}002) of polymer that may be desired for a product. In this example, the grades vary incrementally with each next row and/or column. For example, the difference in the densities or melt indices of G_{—}001 and G_{—}002 may be much less than the difference in the densities or melt indices of G_{—}001 and G_{—}100. The cells in the transition table represent the specific costs levels used to compute the actual transition cost (in dollars) or transition time (in hours). In this example, S denotes small, M denotes medium, L denotes large, P denotes “not permitted”, and D denotes delta. As can be seen, there is no cost associated with transitioning from one product to itself (e.g., G_{—}001 to G_{—}001). In the example shown in FIG. 2, the transition costs increase as the difference in the grade levels increase.

The transition-focused method of scheduling considers the transition table only, and results in a production a schedule that is known as the “product wheel”, as is shown in FIG. 3B. This production schedule steps through the products in an order that minimizes the cost and time of the transitions from one grade of polymer to the next. As can be seen in FIG. 3B, the polymer product B is of a grade that is most similar to the grade of polymer product A, and is therefore scheduled to be produced immediately following the production of polymer product A. This decision has been made even though the demanded delivery date for polymer product B may be later than the required delivery date for polymer product G. Thus, using the transition-focused approach, the production of polymer product G will be delayed, and the customer demand may not be met.

In addition to the problems described above, there may be more than one manner in which a processing line may be transitioned from one operating state corresponding to one polymer grade to another operating state corresponding to a second polymer grade. During the polymer production process, scheduling decisions must be made as to which manner or transition path should be employed in order to maximize efficiency and profitability.

Furthermore, during a transition (in either batch mode or continuous mode), reactants for the previous batch or operating state are moving out of the reactor or processing line, and reactants for the new batch or operating state are moving in. Even if the reactants used are not changed, some time is needed for any new relative compositions, temperatures, etc. to be established. In the case of polymer production, conditions unfavorable to the process may occur during such transitions. In particular, a “fouling” or clogging of the reactor may occur, in which the polymer agglomerates (also called “sticking”, “clumping” or “sheeting”) rather than moving smoothly through the reactor. Clogging of the reactor through this agglomeration generally requires shutdown of the manufacturing process for reactor cleaning, and the accompanying loss of time and product.

It is therefore very important, when beginning manufacture of a new polymer grade, to change the operating conditions of the reactor in such a way that this fouling of the processing line or reactor is avoided. A few specific sets of conditions which tend to give rise to agglomeration (referred to as “sticky zones”) are typically known (by trial and error) to operators of a given processing line or reactor. An approach to avoiding the agglomeration has therefore been to alter the operating conditions during a batch changeover in such a way as to give a very wide berth to these known sets of conditions. Although this approach may result in avoidance of reactor fouling (or at least fouling caused by those particular sets of conditions), it has the disadvantage of potentially making the transition phase unnecessarily long, by excluding conditions along a more direct path between the previous and new batch's conditions. Making the transition phase longer than necessary results in unnecessary lost product and time. Another approach is to try to avoid the agglomeration by the monitoring of a quantity which may correlate with the agglomeration. For example, measurement of static electricity has been used in an attempt to monitor real-time the potential for agglomeration. However, static electricity (as well as other indirect quantities) is not necessarily a sensitive indicator of impending agglomeration. Reliance on such measurements may therefore also result in unnecessary lost product, or may even allow reactor fouling to occur.

Therefore, improved systems and methods are desired for scheduling polymer production.

### SUMMARY OF INVENTION

Various embodiments of a system and method for optimizing polymer production scheduling are disclosed. In one embodiment, the system includes an input which is operable to receive optimization input information, a model of a polymer production system wherein the model includes one or more transition models representing transition behavior of the polymer production system, an optimizer operable to execute the model using the received optimization input information to generate an optimized polymer production schedule, and an output which is operable to output the generated optimized polymer production schedule. The optimized polymer production schedule is usable to manage polymer production with a polymer production system. The polymer production system model may be an analytic model, an empirical model, a rule-based model, a simulation, or some combination thereof.

In various embodiments, the optimization input may include information such as economic information, demand information, customer order information, customer priority information, inventory information, production information and ambient considerations, among others. The optimization input information may further include hypothetical scenario information, an objective, i.e., an objective function, and one or more constraints.

The optimizer may generate the optimized polymer production schedule by attempting to meet the objective subject to the one or more constraints. The optimized polymer production schedule may then be usable to analyze business and production strategies based on the hypothetical scenario information.

In further embodiments, the system may include a controlled polymer production system and an advanced process control coupled to the controlled polymer production system, wherein the optimized polymer production schedule is usable to control the advanced process control. The input may then receive updated optimization input information, which may in turn lead to the optimizer generating an updated polymer production schedule, which in turn may lead to the advanced process control rescheduling polymer production in accordance with the updated polymer production schedule. The system may also receive updated input information in response to an event or a time, which could again ultimately lead to the advanced process control rescheduling polymer production.

The optimized polymer production schedule may include items such as which grade levels to produce for one or more products, what quantities to produce for said products, when to produce said products and when to transition between said products. The optimized polymer production schedule is commonly sequenced to maximize gross profit margin, and may be generated by performing a Large-step Markov Chain Optimization search in a space of possible schedules.

Large-step Markov Chain Optimization may involve determining an initial schedule, determining a search space for the initial schedule specifying a plurality of large-scale permutations of the initial schedule, and performing a large scale permutation of the initial schedule based on the search space to generate an intermediate schedule. The method may then perform a local search around the intermediate schedule to generate a local schedule solution, and then determine if the local schedule solution is accepted. If the local schedule solution is better than the current best schedule, based on certain acceptance criteria, the current best schedule may be set to the local schedule and the initial schedule set to the local schedule solution. The method may then specify additional large-scale permutations of the schedule. If the local schedule solution is not accepted, the method may determine if the ending conditions are met. If ending conditions are not met, the method may continue to carry out large scale permutations on the initial schedule. Finally, the optimized polymer production schedule may be set to the current best schedule. In alternate embodiments, various steps may be performed concurrently, alternated or eliminated.

Possible acceptance criteria for the local schedule solution may include, cost of the initial schedule, cost of the local schedule solution or a time-dependent metric, among others. In one embodiment, the probability of acceptance of the local schedule solution may be calculated by using a simulated annealing process.

Furthermore, large scale permutations of the schedule may be achieved by performing a block insertion of schedule steps, wherein a block of one or more consecutive schedule steps are moved from a source slot to a destination slot in the initial schedule, thereby generating the intermediate schedule. Determining a search space for the initial schedule may include determining a range of block sizes, wherein each block size indicates a number of schedule steps included in the block of schedule steps, determining a range of source slots, wherein each source slot indicates a possible starting point for the block of one or more consecutive schedule steps, and determining a range of destination slots, wherein each destination slot indicates a possible insertion point for the block insertion, wherein said optimizer is operable to iterate through at least a portion of each of the range of block sizes, the range of source slots, and the range of destination slots for each initial schedule, and wherein each iteration corresponds to a large-scale permutation of the initial schedule. Meanwhile, determining if ending conditions are met may include determining if the search space for the initial schedule has been exhausted, determining if a maximum number of iterations has been performed or determining if a maximum time period has elapsed.

Thus, an optimizer may utilize a model of a polymer production system comprising one or more transition models representing transition behavior of the polymer production system to optimize polymer production scheduling.

### BRIEF DESCRIPTION OF THE DRAWINGS

A better understanding of the present invention can be obtained when the following detailed description of the preferred embodiment is considered in conjunction with the following drawings, in which:

FIG. 1 illustrates an example of polymer plant production;

FIG. 2 illustrates the demand-focused method of polymer product scheduling according to the prior art;

FIG. 3A illustrates an example of a transition table according to the prior art;

FIG. 3B illustrates the transition-focused method of polymer product scheduling according to the prior art;

FIG. 4A illustrates an example of a transition in a polymer production sequence;

FIG. 4B illustrates multiple possible transition paths in a polymer production sequence;

FIG. 4C illustrates an example of a sticky zone;

FIG. 5A illustrates the concept of automated decision making, according to one embodiment of the invention;

FIG. 5B illustrates the application of the automated decision making system to a process, according to one embodiment of the invention;

FIG. 6A illustrates, according to one embodiment;

FIG. 6B illustrates, according to one embodiment;

FIG. 7 illustrates a simplified and exemplary view of one embodiment of a system, according to the present invention;

FIG. 8 illustrates a method of schedule objective function calculation, according to one embodiment of the invention;

FIG. 9 illustrates a polymer scheduling system within a polymer plant, according to one embodiment of the invention;

FIG. 10 illustrates a hierarch of decision/control systems, according to one embodiment;

FIG. 11 illustrates a Large-Step Markov Chain optimization method, according to one embodiment;

FIG. 12 is a solution density plot for a search space, according to one embodiment;

FIG. 13 flowcharts a method for generating an optimized polymer production schedule, according to one embodiment;

FIG. 14 is a detailed flowchart of one embodiment of the method of FIG. 13; and

FIGS. 15A and 15B illustrate embodiments of visual displays of information related to polymer production scheduling.

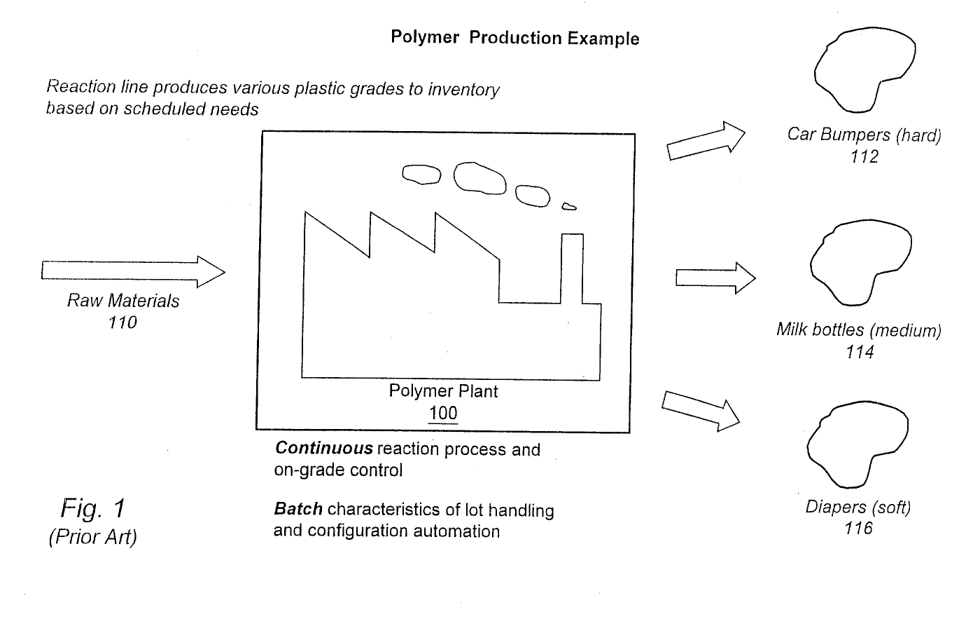

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF THE EMBODIMENTS

Incorporation by Reference

The following publications are hereby incorporated by reference in their entirety as though fully and completely set forth herein.

“Large-Step Markov Chains for the Traveling Salesman Problem” by Olivier Martin, Steve W. Otto, and Edward W. Felten, published in Complex Systems, v. 5:3, pg. 299, 1991.

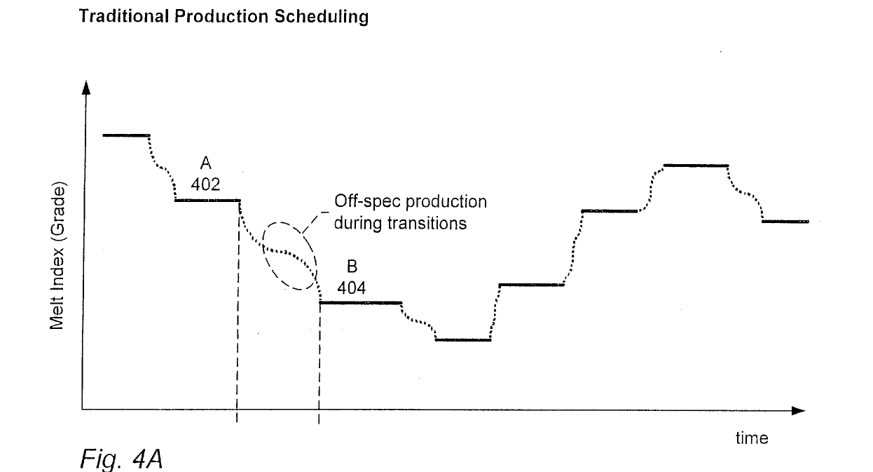

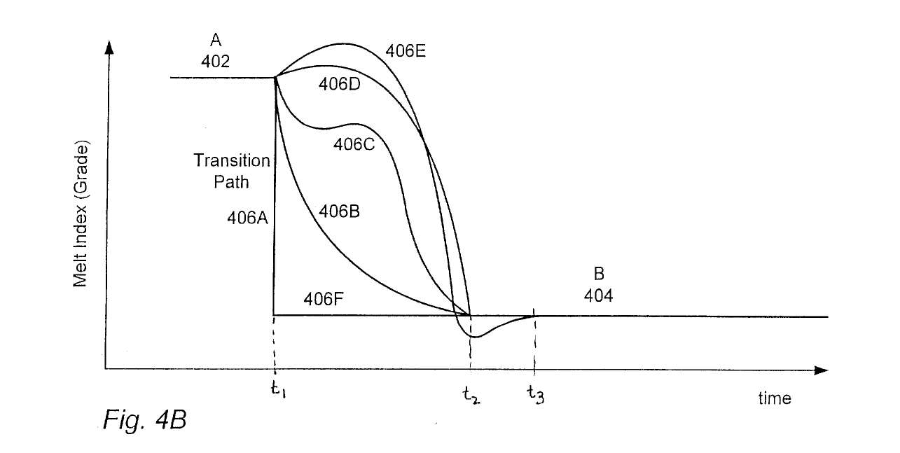

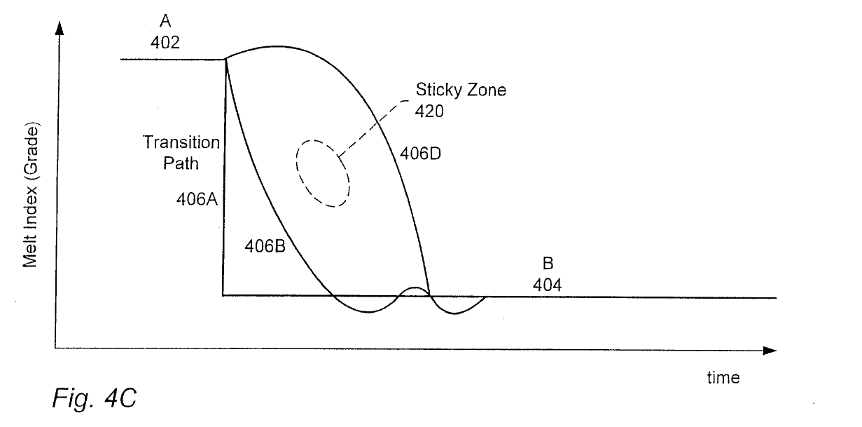

FIG. 4A—Transitions.

FIG. 4A illustrates in more detail the transition from the production of one grade of polymer 402 to the production of a different grade of polymer 404. As discussed previously, the polymer product produced during the transition may not meet one or more required specifications, and thus may be unusable. In one embodiment of the invention, a polymer production schedule is optimized in a manner that considers the behavior of a polymer production process 710 during the transition from one polymer grade to another. Aspects of transitions from one polymer grade to another are further described in FIGS. 4B and 4C below.

FIG. 4B—Example of More than One Possible Transition.

FIG. 4B illustrates an example of a transition for which more than one transition path 406 is possible. One possible transition path 406A may be to discontinue operation of the processing line at time t1, and start operation again after setting the operating conditions of the processing line for the production of the new grade of polymer 404. Another possible transition path 406F may be to force the operating conditions from those required for polymer grade A to those required for polymer grade B with minimal transition time (t2). Other transition paths may be possible. The one or more transition paths may require varying lengths of time from the end of steady-state production of one grade of polymer 402 (t1) to the beginning of the steady-state production of a different grade of polymer 406 (t2-t4). Furthermore, the one or more transition paths may result in varying costs associated with such one or more transitions.

FIG. 4C—Sticky Zone;

FIG. 4C illustrates one example of a sticky zone 420 that may be encountered when transitioning from the production of one grade of polymer 402 to a different grade of polymer 404. As was described above, the sticky zone 420 refers to one or more specific sets of conditions which tend to give rise to agglomeration that may be caused by one or more changes in operating conditions of the reactor or processing line. As is shown in FIG. 4C, one or more transition paths 406 may be employed to avoid the sticky zone 420.

In one embodiment of the invention, a polymer production schedule is optimized by one or more automated decision making processes.

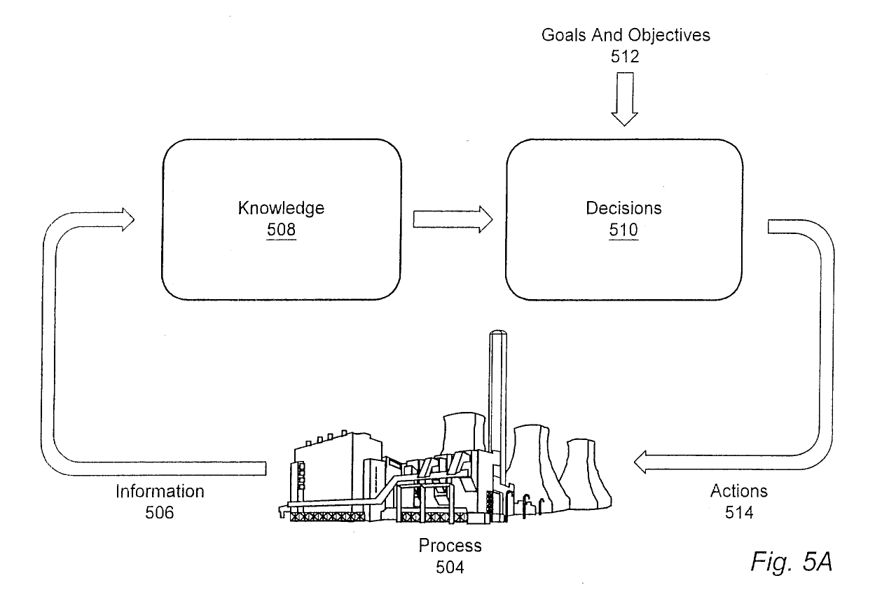

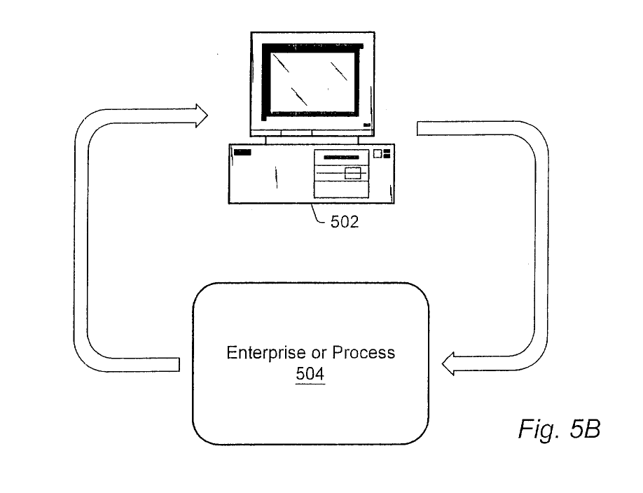

FIG. 5A—Automated Decision Making.

FIG. 5A illustrates the concept of automated decision making. In automated decision making, it is presumed that a process or system 504 exists upon which decisions are to be made. Part of the automated decision making process is to collect data, e.g., historical data of that process, and use this information 506 to build knowledge 508 about how the process behaves. This learning or knowledge 508 may be continually added to or refined as the process 504 is controlled. The information or knowledge 508 that is gathered over time can then be used to make intelligent decisions 510. For example, the knowledge about how the process behaves can be combined with goals and objectives 512 of how the process is desired to behave in order to generate actions 514 that can be used to manipulate the behavior of the process or system 504. Thus, a model of the system or process can be used in addition to a solver or optimizer that optimizes the process according to a desired problem formulation or objective function.

FIG. 5B—Application of the Automated Decision Making System to a Process.

FIG. 5B illustrates a simplified view of the application of an automated decision making system to an enterprise or process 504. As shown, the system may include one or more computer systems 502 which interact with a process, system or enterprise 504 being modeled, optimized and/or controlled. The computer system 502 may represent any of various types of computer systems or networks of computer systems which execute software program(s) according to various embodiments of the invention. The software program(s) may perform various aspects of modeling, prediction, optimization and/or control of the process 504. Thus, the automated decision making system may provide an environment for the decision making process of gathering data, accumulating knowledge, and creation of models of the process for predictive modeling or control. The system may further provide an environment for making optimal decisions using an optimization solver, and carrying out those decisions, e.g., to control the enterprise.

One or more software programs that perform modeling, prediction, optimization and/or control of the process 504 may be included in the computer system 502. Thus, the system may provide an environment for a scheduling process of programmatically retrieving information relevant to the resources or activities used in a system, process or enterprise, and updating a costing system for the system, process or enterprise with such information. The system may further provide an environment for programmatically retrieving information relating to state costs from the system, process or enterprise. Additionally, the system and method may further provide an environment for applying the results of the costing system to the operation and/or optimization of the process, system or enterprise.

The one or more computer systems 502 preferably include a memory medium on which computer programs according to the present invention are stored. The term “memory medium” is intended to include various types of memory or storage, including an installation medium, e.g., a CD-ROM, or floppy disks, a computer system memory or random access memory such as DRAM, SRAM, EDO RAM, Rambus RAM, etc., or a non-volatile memory such as a magnetic medium, e.g., a hard drive, or optical storage. The memory medium may comprise other types of memory as well, or combinations thereof. In addition, the memory medium may be located in a first computer in which the programs are executed, or may be located in a second different computer which connects to the first computer over a network. In the latter instance, the second computer provides the program instructions to the first computer for execution.

Also, the computer system(s) 502 may take various forms, including a personal computer system, mainframe computer system, workstation, network appliance, Internet appliance or other device. In general, the term “computer system” can be broadly defined to encompass any device having a processor which executes instructions from a memory medium.

The memory medium preferably stores one or more software programs for performing various aspects of dynamic cost accounting. The software program(s) are preferably implemented using component-based techniques and/or object-oriented techniques. For example, the software program may be implemented using ActiveX controls, C++ objects, Java objects, Microsoft Foundation Classes (MFC), or other technologies or methodologies, as desired. A CPU, such as the host CPU, executing code and data from the memory medium comprises a means for creating and executing the software program according to the methods or flowcharts described below.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as networks and/or a wireless link.

According to one embodiment of the invention, the decisions 510 may be made in accordance with an explicit set of rules that directly computes the decisions 510 based on the knowledge of the process 508 and the goals and objectives 512, described below. According to an alternative embodiment of the invention, the decisions 510 may be made by an implicit decision generator as described below.

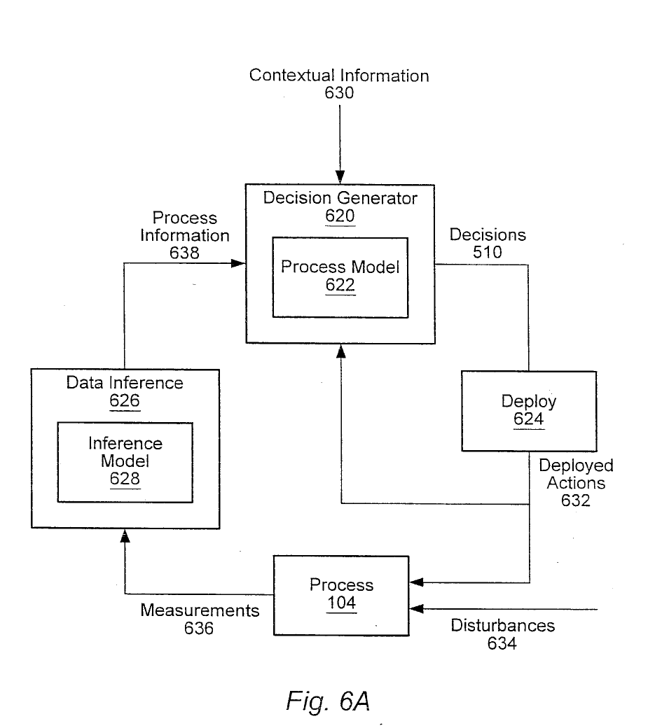

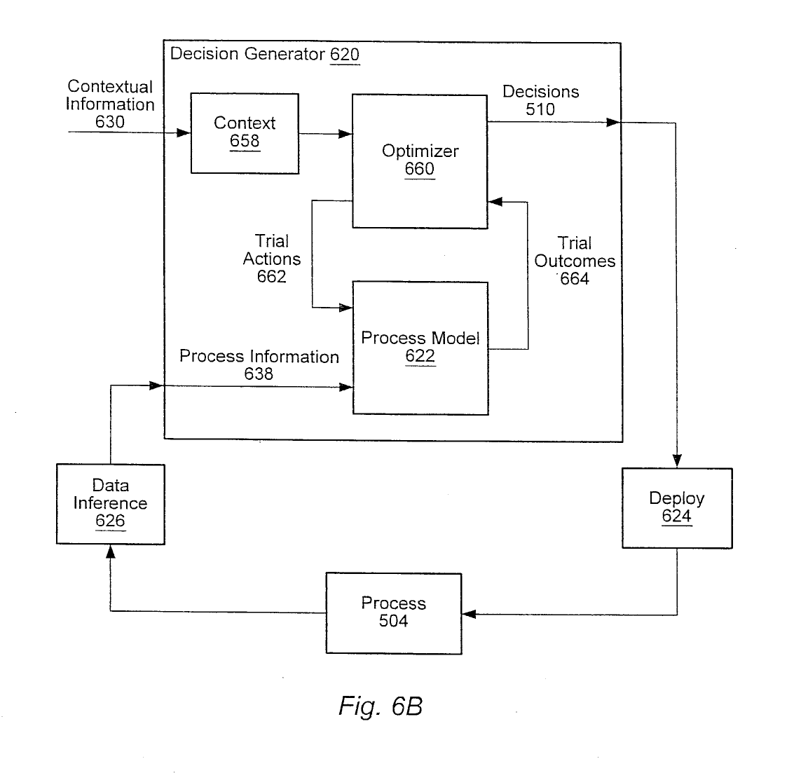

FIG. 6A—Automated Decision Making System.

FIG. 6A illustrates one embodiment of an automated decision making system that employs a model of the process. In general, the goal of the automated decision making process may be to make decisions 510 regarding a process 104 in accordance with received contextual information 630 and process information 638. The decisions 510 may affect the outcomes of the system or process by providing decisions 510 to the process 104. In one embodiment, the contextual information 630 may include objectives and constraints, and the process information 638 may include information regarding the state of the process 104.

The process 104 may receive deployed actions 632 and produce outputs that characterize the operation of the process, seen in FIG. 6A as measurements 636. The decision generator 620 may receive observations from the process 104 in the form of process information 638 and may use that information to make the appropriate decisions. The decision generator 620 may receive contextual information 630 that may guide the operation of the decision generator 620, and informs the decision generator 620 of the goals of how the process 104 is to be operated. These goals may include objectives.

Thus, in one embodiment of the present invention, the decision-making process may be repeated and thus form a cyclic process. In one embodiment, contextual information 630 (e.g., objectives and constraints) and process information 638 may be provided to the decision generator 620. The decision generator 620 may create decisions 510 that are fed to the process 104. The operation of the process 104 produces measurements 636 that may be fed back to the decision generator 620 as process information 638 for the next set of decisions 510.

In the embodiment shown in FIG. 6A, the decisions 510 provided by the decision generator 620 may be deployed 624 as deployed actions 632 to the process 104. The decisions 510, which may be the desired inputs that are to be applied to the process 104, may be different from the deployed actions 632 that are actually deployed within the process. That is, the desired inputs to the process may not be what are ultimately applied to the process 104. Since the decision generator may need to know what actions were actually applied to the system, the deployed actions 632 may be provided back to the decision generator 620. For example, a decision 510 may be to open a valve used in the process 104. However, when actually deployed, the valve may become stuck. The decision 510 may be to open the valve to 90%, but since it is stuck and can only be opened to 80%, the deployed action 632 may be the opening of the valve only 80%.

In one embodiment of the invention, the data inference 626 may receive measurements 636 from the process, and may produce process information 638 from the measurements. The data inference 626 may employ an inference model 628 to generate the one or more process information. This inference model 628 may be different from the process model 622 used in the decision generator 620. The direct measurements 636 of the process 104 may not be usable by the decision generator 620 and may need to be converted to a form that is appropriate and usable by the decision generator 620. In one embodiment, the data inference 626 may receive one or more measurements 636 from the process 104 and may convert the measurements 636 to process information 638 that is appropriate and usable for the decision generator. For example, there may be a limited number of measurements 636 from the process, but the decision generator may require more process information 638. Addition measurement information 638 may be inferred by the data inference 626 using the inference model 628 and the available measurements 636.

In addition to the deployed actions 632 that are applied to the process 104, there may be one or more disturbances received by the process 104. These disturbances 634 may include one or more external influences that may be beyond the control of the decision generator 620 and affect the outcome of the process 104.

In one embodiment of the invention, the decision generator 620 uses a model of the process 104 to generate decisions 510. The process model 622 may represent knowledge or information about how a process or activity within the enterprise behaves. This process model 622 may emulate the input-output behavior of the real process for the purpose of computational experimentation. Examples of types of process models may include, for example, a predictive model, an analytic mode, empirical model, rule-based model, and a simulation, among others. It should be understood that in one embodiment of the invention, such as an embodiment that includes a rule-based model, for example, the decision generator may not include the process model, but may make decisions based on rules that may have been previously determined in accordance with the process model 622.

Thus, it may be seen that according to one embodiment of the invention, the decision-making process may include a sequence of the following steps:

Gather process information 638 from the system or process 104;

Analyze the process information 638;

Make one or more decisions 510 based on the contextual information 630 and process information 638. A process model 622 may be employed to make one or more of the decisions 510;

Provide the decisions 510 to the process 104 as deployed actions 632;

Observe the outcome of these deployed actions 632; and

Repeat this process if necessary.

FIG. 6B—Optimizer

FIG. 6B illustrates the use of an optimizer 660 in the decision making process, according to one embodiment of the invention. The process model 622 may be used to test the effects of potential decisions 510 to be applied to the process by applying trial actions 662 to the process model 622 and observing the model outputs shown as trial outcomes 664 in FIG. 6B. Through this computational testing, the set of trial actions 662 that lead to the desired trial outcomes 664 may be provided as decisions 510 produced by the decision generator 620. Thus, the optimizer 660 may perform the task of determining the optimal set of decisions 510. The decision generator 620 may use an internal strategy to select the trial actions 662 based on how they affect the trial outcomes 664. The optimizer 660 may use one or more objectives that may measure the overall quality of the trial actions 662. An objective specifies a desired outcome or goal of an optimization process. For example, the objective may be to maximize profit, or to minimize missed orders, or both. Of course, other objectives are also contemplated.

The optimizer 660 may use one or more constraints that may restrict the selection of one or more trial actions and/or otherwise affect the trial outcomes. Constraints may include any type of limitations inherent or imposed on the system or process, such as, for example, upper or lower bounds on various parameters involved in the polymer production process, and bounds or values related to economic aspects of the production process and/or business, among others. One goal of the decision generator may be to determine the actions or decisions 510 that provide the best or optimal value for the objective. The optimizer 660 may be a search strategy that applies trial actions 662 and observes the outputs of the process model 622 to determine the quality of the actions and/or trial outcomes and select new trial actions 662. In one embodiment, examples of such search strategies may include evolutionary algorithms, genetic algorithms, and/or scatter search algorithms, among others. In one embodiment of the invention, the optimizer 660 may include a gradient-based method the uses gradient information from the process model 622 and objective to determine the next selection of trial actions 622. Examples of gradient methods are generalized reduced gradient algorithms, sequential quadratic programming algorithms, simplex algorithms, and interior point algorithms, among others. Gradient methods may be employed such that the gradient information can be used to determine the search direction that improves the value of the objective.

In other embodiments, the optimizer 660 may use other types of optimization algorithms which are well known in the art, such as, for example, constraint programming, branch and bound, branch and cut, and decomposition algorithms such as benders decomposition, generalized benders decomposition, outer approximation, or lagrangian relaxation, among others. The set of optimization algorithms contemplated may further include hybrid algorithms combining one or more of the above methods.

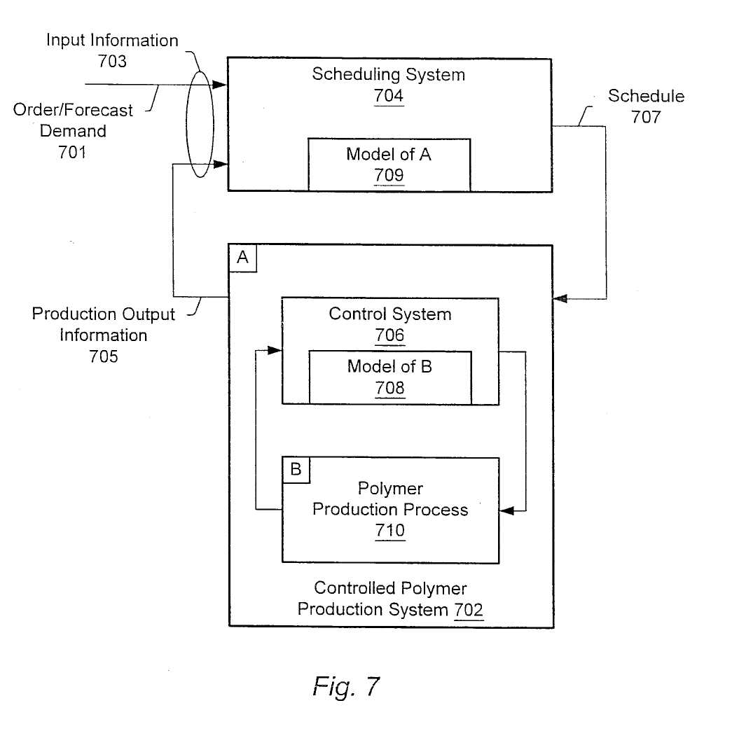

FIG. 7—System for Optimizing Polymer Production Scheduling.

FIG. 7 illustrates a simplified and exemplary view of one embodiment of the invention. As shown, a polymer scheduling system 704 may include a model 709 of the controlled polymer production system 702. In other words, the model 709 may include the model of the polymer production process or system 710, and may also include a model of the control system 706, i.e., an advanced process control, operable to model control operations of the polymer production system.

In FIG. 7, the controlled polymer production system 702 is represented as block A, and the model of the controlled polymer production system 702 is represented as model of A 709. The scheduling system 704 may use the model of A 709 to address the scheduling of polymer products in the polymer production process 710. In one embodiment of the invention, the scheduling system may include an optimizer in the manner described in more detail with reference to FIG. 6B above. In another embodiment of the invention, the scheduling system may include an automated decision generator in the manner described in more detail with reference to FIG. 6A above. In one embodiment, the model may include an objective and one or more constraints, where the optimizer may use the objective and one or more constraints to generate the optimized polymer production schedule 707, and where the optimized polymer production schedule attempts to meet the objective subject to the one or more constraints.

The controlled polymer production system 702 may include a control system 706 that may control the polymer production process 710. The control system 706 may be a model predictive control system that includes a model of the polymer production process 710. In FIG. 7, the polymer production process 710 is represented as block B, and the model of the polymer production process 710 is represented as model of B 708. In one embodiment of the invention, the controlled polymer production system 702 may include an optimizer in the manner described in more detail with reference to FIG. 6B above. In another embodiment of the invention, the control system 706 may include an automated decision generator in the manner described in more detail with reference to FIG. 6A above.

The model of A 709 and/or the model of B 708 may include knowledge or representation of the behavior of the polymer production process during a transition from the production of one polymer grade type to another polymer grade type, i.e., one or more transition models. The behavior of the process 710 may be of a mix of continuous, semi-continuous, and/or batch processing types.

The scheduling system 704 may use the model of process A 709 along with input information 703 to establish a schedule that accounts for different competing goals. The input information 703 may include, among other information, business drivers such as order/forecast demands 701, as well as production output information 705, in optimizing a polymer production schedule 707. In other words, the scheduling system 704 may use an optimizer to execute the model 709 using the objective and one or more constraints to generate an optimized schedule solution for the polymer production process which attempts to meet the objective subject to the one or more constraints.

In the embodiment of the invention shown in FIG. 7, the tasks associated with control system 706 and those associated with the scheduling system 704 may be decomposed in order to simplify the decision-making task in the scheduling system 704. The decision-making tasks of the scheduling system 704 and the control system 706 may be combined into one decision-making task that uses an appropriate time horizon, time scale, and objective function. However, doing so may lead to a problem that is difficult to solve. The decomposition may allow different aspects of the decision-making to be separated into simpler problems. The scheduling system 704 may determine when, where, and how much of the product to make over some time horizon, and the control system 706 may control the polymer production process such that targets specified by the scheduling system 704 are met. The scheduling system 704 may use the model of A 709 in a manner that allows the scheduling system 704 to generate a schedule 707 that the control system 706 is able to track.

The input information 703 to the scheduling system 704 may include information used to drive or constrain the scheduling system 704. This may include, for example, the demands for the products that are to be manufactured by the polymer production process 710. These demands may be determined from customer orders or from a forecast of customer orders. The input information 703 may also contain any directive information from a higher-level, controlling decision-making process. This information may restrict or constrain the scheduling system. For example, in a case where the polymer production process 710 consists of multiple production lines where each line is capable of producing multiple products, a higher-level decision-making process may have determined that certain products may only be manufactured on specific production lines. Thus the scheduling system may be restricted in its decisions about where products can be manufactured. The input information may also include updates of economic information, updates of transition information, or updates of other model information, among other types of information.

The input information 703 may also include the production output information 705, which may include feedback information from the controlled polymer production system 702. This production output information 705 may include the information about the current status or state of the controlled system, including, for example, the current production flows, cumulative production amounts, and other production levels are fed back to the scheduling system. This may then used by the scheduling system 704 to determine a new schedule 707.

In one embodiment of the invention, the model 709 of the controlled polymer production system may be provided to the scheduling system 704. In such embodiment, instead of using a single transition matrix for transition costs and times, a series of transition matrices may be used. Each of these matrices may correspond to different transition options that the scheduler may evaluate and use for the optimal schedule 707. This type of modeling may be discrete in nature as the scheduler may have a discrete set of options from which to choose. More detailed information about the transitions may be captured by using continuous functions that relate an arbitrary transition path to the costs and times associated with the transition. This may allow for a continuum of transition options. In any of these cases, the optimizer may use the transition model information to explore the different transition options and weigh the economic trade-offs of selecting the different options.

Thus, a scheduling system according to one embodiment of the invention may take advantage of the many different possible transition paths 406 and trade-off the effects of the different choices in a systematic way. For example, such a scheduling system may evaluate the outcomes of a fast transition that is costly, a slow transition that is inexpensive, and the option of shutting down the line and restarting to make a grade transition, and choose an optimized transition path 406.

In one embodiment of the invention, depending on the specific characteristics of the products to be made and the order in which they can be made, the actual shape of the trajectory of the production system may be manipulated to improve the overall performance and flexibility of the schedule 707. For example, larger variations in the production levels may be tolerated for some grade levels in comparison to others. The aggregate quality of the collected product may be all that is important and the uniformity may not be as important. In another example, the tolerance boundaries for a one grade may overlap those of another grade in such a way that it may be possible to eliminate the production of any waste material. Thus, the inclusion of the model of the controlled process in the scheduling problem may be used to take advantage of these possibilities.

One embodiment of the invention may include the “sticky zones” and/or the degree of “stickiness” predicted to result from a given set of process conditions. An optimizer within a multivariable predictive control (MPC) approach (also referred to as “model predictive control”) may chooses a transition path 406 between conditions for a previous polymer product grade and those for a new polymer product grade by balancing the need for a short transition phase against an acceptable degree of stickiness (or tendency to agglomeration). This approach in some cases may include a recognition that a controlled amount of agglomeration may be reversible, and therefore manageable, during a transition (e.g., not require a reactor shutdown). Careful control of the predicted degree of stickiness may therefore reduce the transition time and corresponding lost product. An optimizer 660 may interact with a process model 622 that predicts the degree of stickiness as a function of reactor conditions. Conditions may include, for example, ethylene or propylene flow rates, catalyst composition and flow rate, and/or reactor temperature, among others. By incorporating data from observations of agglomeration in a wide variety of reactors under a wide range of conditions, the model may provide greatly improved sensitivity for prediction of agglomeration conditions, and may allow prediction of a degree of agglomeration.

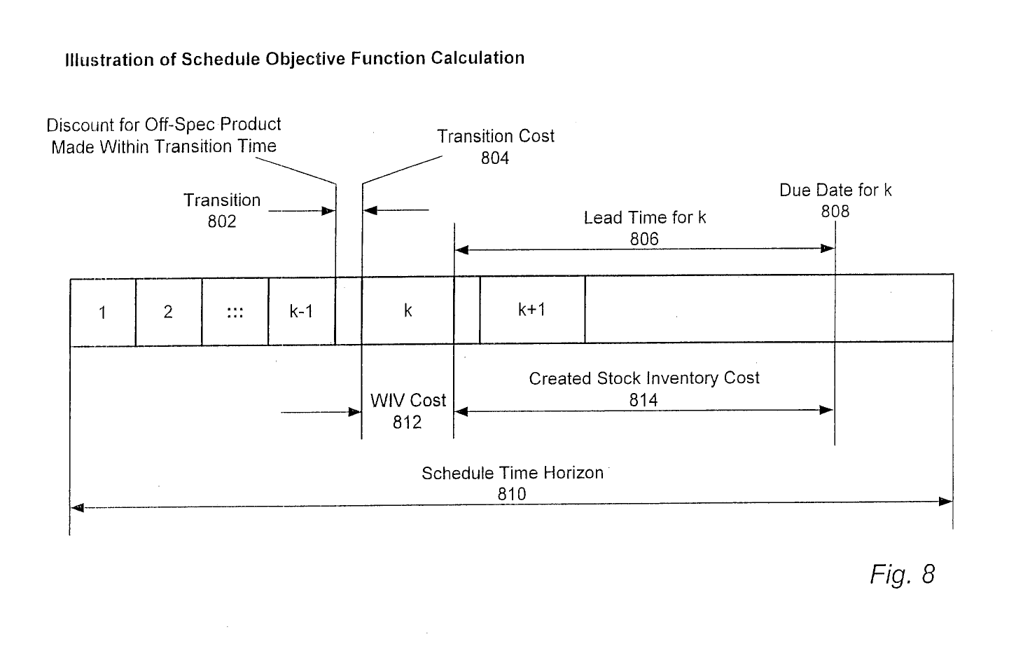

FIG. 8—Schedule Objective Function Calculation.

FIG. 8 illustrates one method of calculating an objective function for the optimization of a polymer schedule according to one embodiment of the invention. In this embodiment, the optimization for polymer scheduling may be formulated with one or more computational objective functions, with costs of the scheduling scenario subject to constraints.

The objective function for the optimization problem may be to minimize the total cost of the production. For a schedule denoted as S, the objective function may be written as

Total_Expense (S)=Storage_Expense (S)

+WIV_Expense (S)

+Rail_Expense (S)

+Trans_Expense (S)

+OffSpec_Expense (S)

+Late_Expense (S),

where the Storage_Expense may be the expense for storing the products, the WIV_Expense may be the expense for the working inventory (storage while the products are being manufactured), the Rail_Expense may be the expense for using a rail car for the products, the Trans_Expense may be the expense for the transitions, the OffSpec_Expanse may be the expense for the off-spec material produced during the transitions or opportunity cost of transition time, and the Late_Expense may be the expense for delivering an order late.

In the embodiment of an objective function calculation represented in FIG. 8, the various individual cost terms may be defined as further described below.

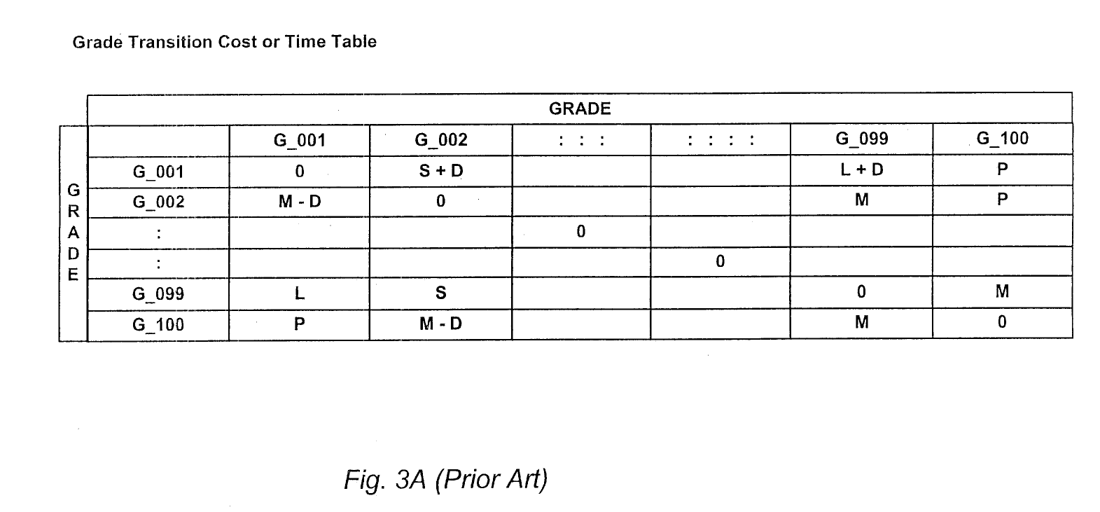

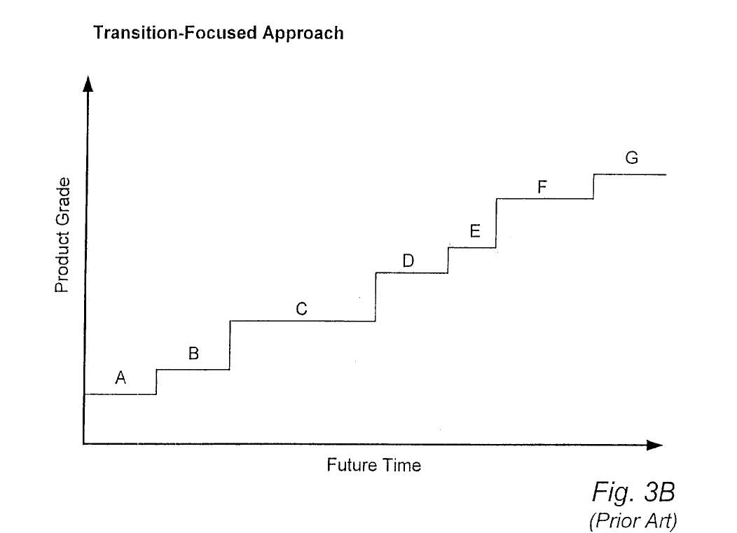

Trans_Expense (S)=Sum{k=1 . . . N−1|Trans_Cost (k, k+1)804}, where Trans_Cost(k, k+1) is the transition cost for the transition 802 between orders k and k+1 and is taken from the grade transition cost matrix as was further described above in reference to FIG. 3A.

OffSpec_Expense (S)=Sum{k=1 . . . N−1|Trans_Time(k, k+1)×RunRate(k)×UnitDiscountPrice (k)}, where Trans_Time(k, k+1) is the transition time between orders k and k+1 and is taken from the grade transition time matrix. UnitDiscountPrice (k) may be a function of market demand conditions and may have a variable value.

Storage_Expense (S)=Sum{k=1 . . . N−1|LeadTime (k)×Qty(k)×UnitStorageCost(k)}, where the LeadTime(k) 806 is the amount of time that order k will be in storage (the time between the due date 808 and the time it was manufactured), Qty(k) is the amount in storage, and UnitStorageCost is the cost of storing the order. The UnitStorageCost(k) is shown in FIG. 8 as the Created Stock Inventory Cost 814, and may have units of $cost per quantity per unit time.

WIV_Expense (S)=Sum{k=1 . . . N−1|0.5×Qty(k)×Unit_WIV_Cost(k)}, where Unit_WIV_Cost 812 is the working inventory cost of the order, and may also have units of $cost per quantity per unit time;

Rail_Expense (S)=Sum{k=1, N−1|Rail_Rent(k)+Rail_Yard_Cost (k)}, where

Rail_Rent is the rental cost for a rail car, and Rail_Yard_Cost is the cost for using the rail yard; and

Late_Expense (S)=Sum{k=1, N−1|LateTime(k)×Qty (k)×Unit_Late_Cost (k)} where LateTime is the amount of time that an order is late, and the Unit_Late_Cost is the cost of delivering an order late.

According to one embodiment of the invention, the optimization problem may be formulated as:

MIN Total_Expense (S)

According to one embodiment of the invention, the optimization problem may be subject to one or more constraints. The constraints may include, for example, one or more of the following among others:

Certain grades may be restricted to production on certain lines (Grade to line map constraints);

Minimum and Maximum capacity constraints on the production rates for the lines;

High priority orders cannot be delivered late; and

Grade levels may be restricted to certain levels at specific times.

Thus, according to one embodiment of the invention, a system for optimizing polymer production scheduling may employ an objective function calculation defined in a manner as to minimize the total cost of production subject to one or more constraints, as described above.

In another embodiment of the invention, a system for optimizing polymer production scheduling may address a polymer-scheduling problem is described as follows:

Given

A set of products

A polymer production system capable of manufacturing these products

the demand of the product at given time periods (ordered or forecasted);

Determine

what product to make

when to make each product

how much of each product to make;

and in so doing, consider the following:

Value of products or value of filling an order

Cost of manufacturing products

Cost of transitions from on material to another

Cost of storing products before delivering them

Cost of missing demands;

Time to cost conversion required for transitions

as well as one or more of the following non-economic issues:

Priority of the customers.

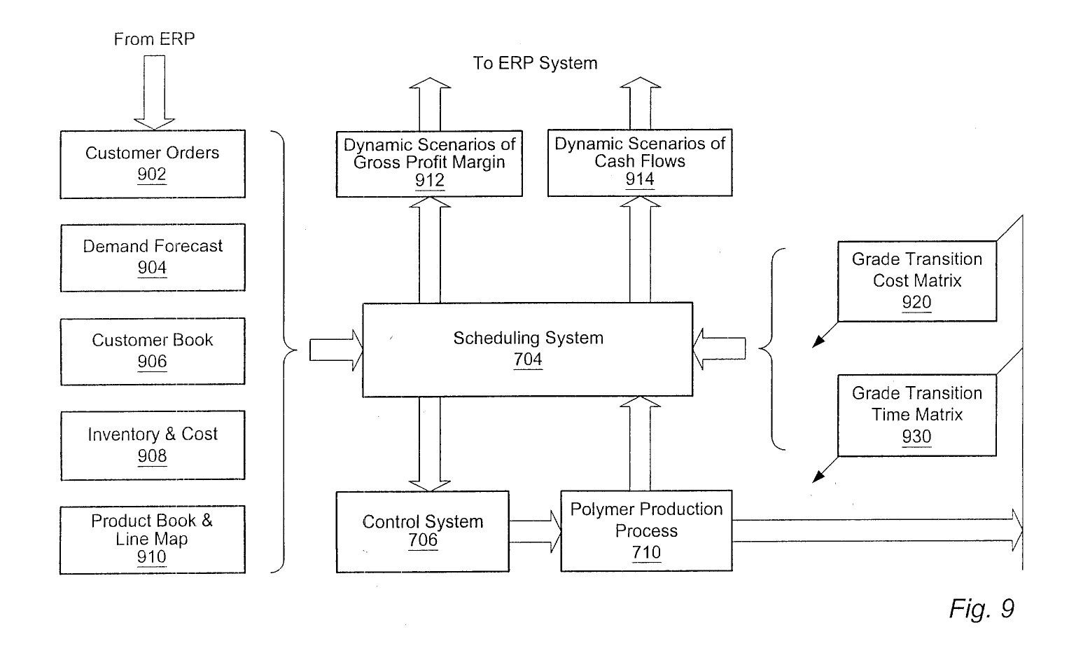

FIG. 9—Polymer Scheduling System within a Polymer Plant.

FIG. 9 illustrates the manner in a polymer scheduling system may interact with other systems within a polymer plant 100 according to one embodiment of the invention.

As described in more detail above, the scheduling system 704 may determine an optimized polymer production schedule and provide the optimized schedule to a control system 706. The control system 706 may control or manage the polymer production process 710 in accordance with optimized schedule. The scheduling system 704 may receive information from the polymer production process 710, and such information may include, for example, production output information 705.

In the embodiment shown in FIG. 9, the scheduling system may receive information from one or more systems, including, for example, customer orders 902, demand forecast 904, customer book 906, inventory and cost 908 and product book and line map 910, among others. The sources for such information may be internal or external to the polymer plant 100. The information received from other systems may have, in turn, been received from one or more enterprise resource planning (ERP) systems. ERP systems may monitor, track and/or manage resources within an enterprise. The scheduling system 704 as shown in FIG. 9 may also receive information from one or more grade transition cost matrices 920 and/or one or more grade transition time matrices 930, which were described in more detail above in reference to FIG. 3A. Thus the scheduling system 704 may generate an optimized polymer production schedule while considering information relating one or more demands and conditions received from other systems that may be internal or external to the polymer plant 100.

In the embodiment shown in FIG. 9, the scheduling system 704 may also provide information relating to polymer production schedules to one or more systems capable of dynamically producing and/or evaluating one or more scenarios taking into account the received schedule information. Such systems may include, for example a system capable of producing and/or evaluating dynamic scenarios of gross profit margin 912, and a system capable of producing and/or evaluating dynamic scenarios of cash flows 914, among others. Dynamic scenario systems such as systems 912 and 914 may operate to perform offline (what-if) analyses. The offline usage of the scheduler may allow for addressing business issues such as Ability-to-Promise (ATP) and Profitable-to-Promise (PTP). ATP relates to the assessment of whether the scheduling system 704 is able to accept an order (e.g., a customer order for a specific grade of polymer) and include it in a production schedule. If for example, a customer requests a polymer product of a specific grade, the use of dynamic scenario systems such as system 912 may provide information regarding the polymer plant's ability to promise the delivery. PTP relates to the further assessment of whether or not it is profitable for the polymer plant to manufacture a requested order.

The scheduling system 704 may provide one or more finance scenarios that may be provided to a business system for a given schedule or set of schedules under a defined time frame. The one or more finance scenarios may include, for example, overall cash flows with time for orders, product groups and customers, overall gross profit margins with time for orders, product groups and customers; and real time tracking and rescheduling.

In one embodiment of the invention, the scheduling system 704 may be employed to track the status of the execution of the optimized production schedule generated by the scheduling system 704. In such embodiment, as the optimized production schedule is being executed by the polymer production process 710, the actual outcomes of the process can be viewed and compared to the schedule. The scheduling system 710 may create a new schedule, or reschedule based on an event or based on a time (regular or irregular interval).

Once a schedule is generated, it can be viewed as a static plan that is executed over the time horizon. As time progresses, the orders on the schedule are manufactured as indicated on the schedule. However, there are times that the schedule should be regenerated based on the current conditions and any new information. This rescheduling can happen automatically or manually.

There are a variety of cases where rescheduling may be warranted, including, but not limited to:

Schedule Slip—In this case, the execution of the schedule is different from the original plan. As the schedule is being executed either unexpected behavior in the process operation or disturbances to the process cause the actual production to deviate from the schedule. When this deviation is too large, a new schedule must be created.

Order Change—Additional orders are always being taken, and sometimes these orders may need to be filled within the horizon of the current schedule. If this is the case, then the schedule will need to be regenerated with the new information.

Model Parameter Changes—The cost parameters used for the economic evaluations used in the scheduling task may change over time. This may be due to the change in weather, improvements in the process and/or transition method, or changes in the raw materials. When this happens, a new schedule will need to be generated to reflect the new information.

In one embodiment, a rolling horizon approach may be used to direct rescheduling, where input information may be updated and a new schedule generated at some regular time interval, maintaining a substantially constant schedule horizon corresponding to a specified forecast period. In another embodiment, once the current schedule has been substantially performed, a replacement schedule may be determined for the next forecast period.

Thus, the scheduling system 704 may be used within the polymer plant in a variety of ways. As shown in FIG. 9, one embodiment of the scheduling system may be employed offline to generate predictions and/or simulations. The scheduling system 704 may be employed online to control and/or optimize the polymer production process. Such online control and/or optimization may be performed in real-time. The production plan schedules and related information generated by the scheduling system 704 may be generating using information supplied to the scheduling system 704 from other systems that may be internal or external to the polymer plant 100. The information supplied the scheduling system 704 may include information regarding the polymer production process 710 as well as business and/or financial information such as, for example, customer orders 902, demand forecast 904, and grade transition costs, among others.

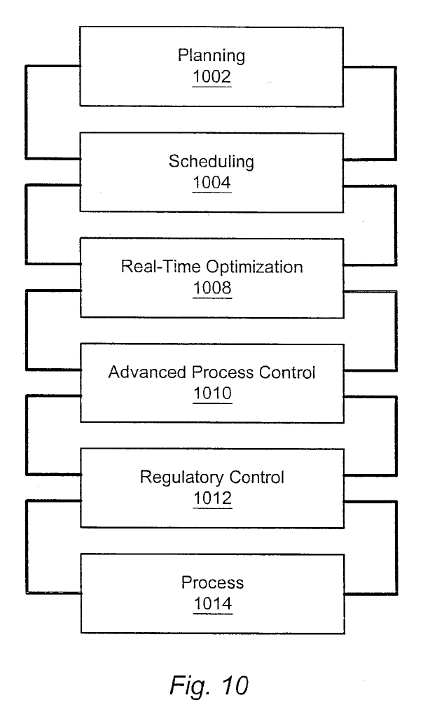

FIG. 10A—A Hierarchy of Decision/Control Systems

FIG. 10 illustrates the manner in which the schedule objective function described with reference to FIG. 8 may be decomposed into a hierarchy of decision-making operations, according to one embodiment of the invention. At the top of the hierarchy, long-term, broad scope decisions may be made while at the bottom of the hierarchy, short-term, narrow scope decisions may be made. In one embodiment of the invention, decomposition includes, from the top down, planning 1002, scheduling 1004, real time optimization 1008, advanced control 1010, and regulatory control 1012. The decision flow may be from the top down as decisions made at the higher layer are used by the lower level task.

In one embodiment of the invention, planning 1002 and scheduling 1004 may refer to the tasks of determining which products to make along with when, where, and how to make them so as to meet customer demands while operating in the most efficient manner. The terms planning and scheduling may have different meanings depending on the application. In a discrete process, the scheduling task may be focused on determining the particular steps that must be taken in order to assemble the final product. In a batch process, the scheduling task may be focused on determining the assignment of tasks to units in order to achieve the necessary processing steps to create the desired products. In a continuous process, the scheduling task may be focused on determining when transitions between products occur and how much to produce. Within each of these categories, the problem may be different depending on the specific details such as length of the scheduling horizon, scope of the scheduling task, calculation of operating costs, sales revenue, and inventory, and different operating strategy alternatives. Planning 1002 may be a form of scheduling 1004 at a higher level, and may include the scheduling 1004 of polymer products on multiple processing lines in multiple geographic locations, for example.

In the embodiment shown in FIG. 10, each block in the decomposition represents a decision-making process that may receive directive information from the block above it in terms of contextual input and feed back information from the lower block in terms of measurements. Each block then may determine the decisions that are applied to the block below. Each of the different blocks may focus on a different time-scale and scope related to the operation of the process. In one embodiment of the invention, the hierarchical decomposition may have the longer-term, broader-scope decisions at the top and the shorter-term, narrower-scope decisions at the bottom with the process itself being at the very bottom. This decomposition of tasks and definition of the scope, scale, and function of each may be arbitrary. The decomposition may differ from one type of manufacturing process to the next, and from one company to the next.

The decomposition may be based on issues of time scale and scope. Decisions that have the same time scale or scope may be made in the same decision-making process. The decomposition may also result based on tractability and solvability. By using this decomposition, the problems that are formulated may be easier to solve in practice.

In polymer manufacturing, the planning function may cover multiple processing lines and may include a time scale that ranges over varying periods of time. For example, a planning function may span several months, or may span a year, or some other period of time. The decisions may include, for example, what products should be available to manufacture and what products will be manufactured on which lines. In some cases, the planning function may take order information (demanded and forecasted) and determine which orders should be made on which lines.

In one embodiment of the invention, the scheduling task may have a time scale of several months (shorter than planning) on one or more processing lines. The scheduling task may determine when, where, and how much of the products to make in order to satisfy demand.

In one embodiment of the invention, the planning and scheduling functions may be viewed in the following way. The planning task may be focused on determining the allocation of orders to multiple processing lines, and may perform functions such as order splitting (making a large order into smaller orders) and order grouping (merging several small orders of the same product into a larger order). This focus of the scheduling task may be to determine the sequence of the orders on the individual processing lines, and may take the information from the planning task about which orders are to be manufactured on the given line and then sequence these orders to minimize a cost function that includes manufacturing costs, transition costs, and late delivery costs. In another embodiment, the planning and scheduling tasks may be grouped together in one decision-making process.

In one embodiment of the invention, the real-time optimization function 1008 may include a time horizon of some period of time, and may include a scope of one or more processing lines. This function 1008 may take the schedule information about what products are to be manufactured on a processing line and determine the optimal set points for the units within the process. It may determine how the process should be operated in order to meet the targets specified by the scheduler. The information determined by the real-time optimization may include, for example, the desired trajectories and set points for the advanced process control layer. In one embodiment of the invention, the advanced process control system 1010 may include a time scale and scope. The time scale may range, for example, from several minutes to hours, and the scope may include, for example, only a single unit or multiple units. Other time scales and scopes may be included. (In another embodiment, the entire processing line may be viewed as a single unit in which case the real-time optimization block and the advanced process control block have the same time scale and scope.) The focus of this system 1010 may be on set point regulation. The advanced process control system 1010 may track the desired trajectories determined by the real-time optimization task and may attempt to minimize the error between the process outputs and the set points. (In another embodiment, the real-time optimization and the advanced process control layers may be collectively referred to as advanced process control and optimization.) This task may include, for example, a scope of one unit, and within that unit, there may multiple controlled and multiple manipulated variables, and the system may include a multi-input/multi-output system.

In one embodiment, the final regulatory control task 1012 may include a time scale and scope. The time scale may range, for example, from seconds to minutes, and the scope may include, for example, one controlled and one manipulated variable (or more). (In one embodiment, the task may include single-input/single-output systems.) The information, including set points, may be sent from the advanced process control layer to the regulatory control layer. Each of the decisions from the advanced process control may be used by a single or several regulatory control elements. In one embodiment, this layer may be more hardware intensive as the decisions that are made result in physical changes to the process, and may be the level where valves are opened and closed to affect changes to the process.

In one embodiment, the process 1014 may include a continuously operating system. Decisions from the regulatory control may affect the operation of the process and may dictate the outputs of the process. At this level, the outputs of the process may correspond to the physical operation of the process: how much material is produced, the characteristics of that material, the temperatures and pressures within the process, among other aspects of the operation.

In one embodiment, any one of the decision-making processes in the hierarchy may be used to control any lower-level decision-making process. In the embodiment shown in FIG. 10, the decision-making process may be handled by allowing information to be passed through a decision-making task from the level above to the level below.

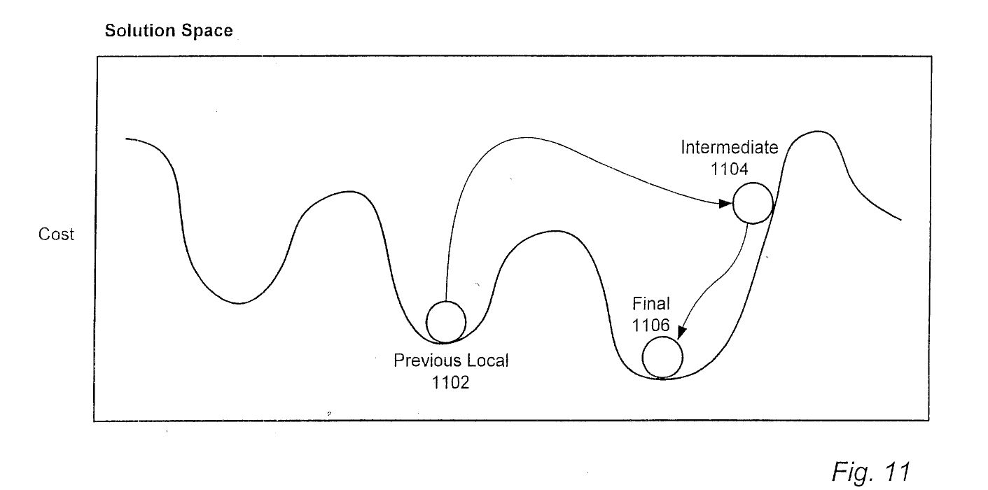

FIG. 11—Large-Step Markov Chain Optimization

Based on the nature of production scheduling problems in many semi-continuous manufacturing processes, where subsets of manufacturing demands form groups or batches, a Large-Step Markov Chain algorithm may be used as part of a polymer scheduling system to determine or generate schedules that sequence manufacturing or production orders to achieve specified goals, such as, for example, to maximize gross profit margin. In this approach, a variable-sized insertion search on a wide search space (of schedules) may be used in conjunction with a k-Opt (e.g., two- or three-Opt) Lin-Kernighan inner search and simulated annealing search method to determine a very good solution (substantially optimal) in the wide search area.

Regular Markov Chains (MC) are often used as a local search algorithm (Lin-Kernighan) with an embedded stochastic method related to simulated annealing. The main drawback of regular MC is that once a local optimum is reached the method may take a long time before reaching another local minimum. This means that the system searches incrementally (i.e., using small-steps) until it reaches another local minimum because it relies on an embedded stochastic method to perform the translation from the old local minimum to the new local minimum. Because of this inefficiency, the simulated annealing approach generally performs slowly even though the temperature profile decreases quickly.

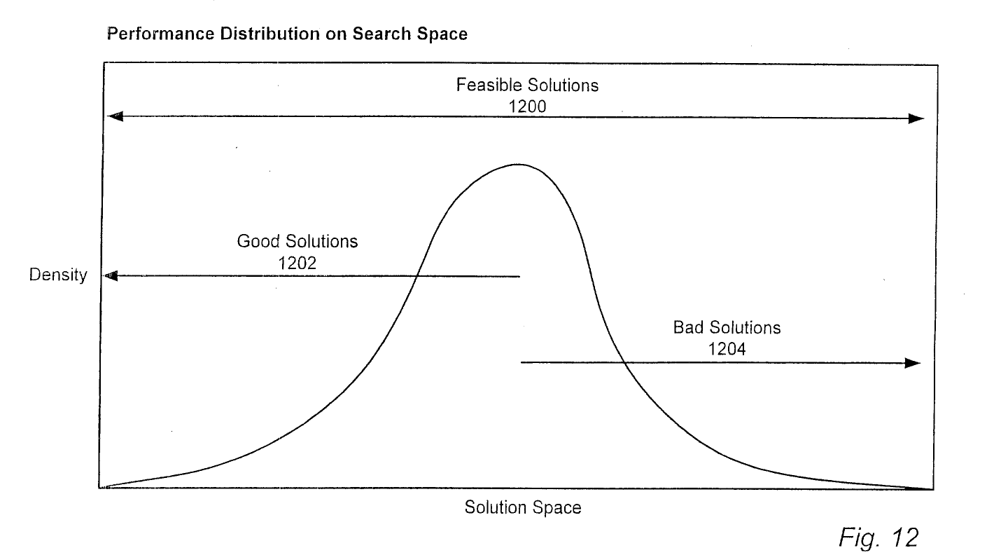

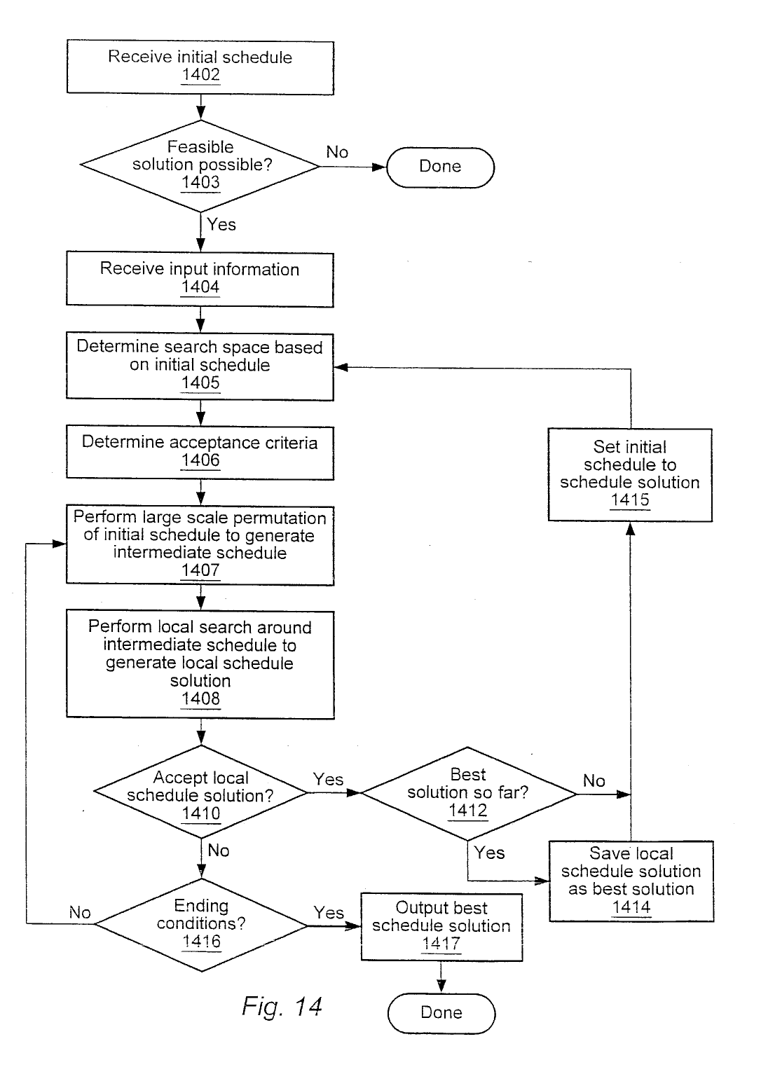

FIG. 11 illustrates one embodiment of a Large-Step Markov Chain optimization process. In the Large-Step Markov Chain method, rather than simply iterating with small steps to search the solution space, at each iteration a new point (schedule) may be calculated by translating or “kicking” the current point 1102 to a ‘far away’ point (intermediate point 1104 in FIG. 11). This “kick” is referred to as a large scale permutation. The method may then bring the solution to a new local minimum (final point 1106 in FIG. 11), via a local search technique (2- or 3-opt Lin-Kernighan search), which may use small-scale permutations to search the local neighborhood of the intermediate point. The stochastic method (simulated annealing) may then determine whether or not the new point will be accepted. An important issue of this approach is the selection of the right translation or kick that will locate a point or solution far away from the current position, and bias the search toward good solutions (see FIG. 12). Thus, the kicking algorithm may be used to obtain the large jumps in the search space and a local search is used to find the best solution after the jump has been made. This approach of following a large-scale permutation with a local search may be iterated to efficiently search the solution space for a substantially optimal solution, as described in detail below with reference to FIG. 14.

In one embodiment, the suitable kick may be accomplished by using a variable-sized insertion method, i.e., a block insertion. This method takes a schedule with size s (i.e., with s schedule slots) and finds n consecutive orders or schedule slots from the schedule that have a natural grouping. This grouping is referred to as a block and corresponds to a portion of the schedule. The method may then take the block and successively insert it into each of the possible s−n+1 slots of the remaining schedule, where each insertion is a large-scale permutation of the schedule, i.e., a kick. For example, a schedule may be represented as A-B-C-D-E-F-G-H, indicating the sequence in which the orders are manufactured. One block within this schedule is BCD, having a block size 3. It is noted that the block size is preferably strictly less than the size of full schedule (8 in this case).

As the method progresses, using a simulated annealing approach, the value for the temperature may decrease such that the probability that a worse solution may be accepted decreases. The way that the temperature decreases may be defined by a nonlinear function of the method progress in terms of an iteration count or execution time. Thus, early in the solution procedure, the probability of accepting a new local solution that is worse than the current one may be relatively high. This allows the method to move to different regions of the search space that may not initially be a better solution but may lead to an overall better solution. As the method proceeds, the probability of accepting a worse solution may decrease until only better solutions are accepted. For more detailed information on Large-Step Markov Optimization, please see the publication “Large-Step Markov Chains for the Traveling Salesman Problem” by by Olivier Martin, Steve W. Otto, and Edward W. Felten, published in Complex Systems, v. 5:3, pg. 299, 1991, which was incorporated by reference above.

FIG. 12—Performance Distribution on Search Space

FIG. 12 illustrates one embodiment of a performance distribution on a search space, represented as a probability distribution of total cost objective function. More specifically, a distribution of best feasible polymer production schedules (proposed, OneOpt, TwoOpt search) over the search space is shown where the solution density has a pronounced peak, compared to other optimization algorithms, i.e. random search and TwoOpt search. Thus, it may be seen that the number of solutions or possible schedules is primarily located in the vicinity of the density peak with the lowest total costs.

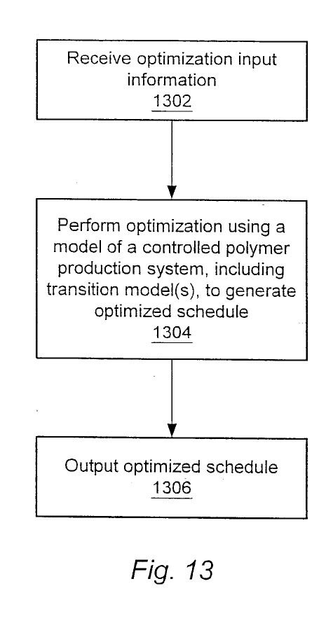

FIG. 13—Method for Scheduling Polymer Production

FIG. 13 is a flowchart of one embodiment of a method for optimizing polymer production scheduling. It is noted that in various embodiments, some of the steps shown may be performed in a different order than shown, or may be omitted. Additional steps may also be performed.

As FIG. 13 shows, in 1302, optimization input information may be received. The optimization input information may include any type of information that is germane to polymer production scheduling. For example, the optimization input information may include one or more of economic information, demand information, demand forecast information, customer information, such as customer order information, customer book information, and customer priority information, inventory information, cost information, such as cost of manufacturing products, cost of transitions between products, cost of storing products prior to delivery, and cost of missing demands, production information, also referred to as process information, product pricing information, product book information, product value information, order value information, line map information, capacity limits, scheduling horizon, and ambient conditions, among others. It is noted that the optimization information may be received from a number of different sources, including external sources, such as real-time data feeds, and/or internal sources, i.e., sources internal to the business or enterprise managing the polymer production process, such as the polymer production process itself, and/or various business or management units in the business or enterprise. In one embodiment, the optimization input information may include hypothetical scenario information which may be used to analyze business and production strategies based on the hypothetical scenario information.

In one embodiment, the optimization input information may include one or more of an objective and one or more constraints, as described above. In other words, the optimization input information may include a goal and/or one or more limitations on the problem and/or solutions generated by the method, i.e., by an optimizer. In one embodiment, the optimization input information may include one or more models for use by an optimizer, such as, for example, a production cost model, inventory cost model, one or more transition models, and/or one or more inference models, as mentioned above. In yet another embodiment, the optimization input information may include parameters and/or coefficients for one or more models used by the optimizer.

In 1304, the optimizer, also referred to as a solver or decision generator, may execute a model of a polymer production system using the received optimization input information to generate an optimized polymer production schedule. The model includes or is coupled to one or more transition models representing transition behavior, such as transition times and/or costs, of the polymer production system. In one embodiment, the model may include an objective, and/or one or more constraints, as described above. In an embodiment where the objective and/or constraints are received as part of the optimization input information, the optimizer may apply the objective and/or constraints during model execution, or alternatively, may apply the objective and/or constraints to results of the model execution. In either case, the optimizer may use the objective and one or more constraints to generate the optimized polymer production schedule, where the optimized polymer production schedule attempts to meet the objective subject to the one or more constraints. In one embodiment, the optimizer executing the model using the received optimization input information to generate an optimized polymer production schedule may include performing a Large-step Markov Chain Optimization Search in a space of possible schedules, as described generally above, and in more detail below with reference to FIG. 14.

Finally, in 1306, the generated optimized polymer production schedule may be output, where the optimized polymer production schedule may be usable to manage polymer production with a polymer production system. In one embodiment, the optimized polymer production schedule may be used to schedule polymer production in a polymer production system. For example the optimized polymer production schedule may be provided to an advanced process control, which may then schedule polymer production by a polymer production system in accordance with the optimized polymer production schedule. As another example, where the optimization input information includes hypothetical scenario information, the optimized polymer production schedule may be used to analyze business and production strategies based on the hypothetical scenario information. In other words, various hypothetical scenarios may be input to the optimizer, and the resulting schedules analyzed to determine beneficial tactics and/or strategies regarding polymer production.

In one embodiment, the optimized polymer production schedule may include one or more of: grade levels to produce for one or more products, quantities to produce of the one or more products, when to produce each of the one or more products, when to transition between the one or more products, and which of one or more process lines to use for each of the one or more products. As mentioned above, the optimized polymer production schedule may sequence manufacturing orders to meet a specified objective, such as, for example, to maximize gross profit margin, or to accomplish some other goal of the polymer production enterprise.

After the method has produced the optimized polymer production schedule, conditions related to polymer production and/or the business environment may change. Thus, in one embodiment, the method steps presented above may be repeated with updated information. In other words, updated optimization input information may be received, the optimizer may execute the model using the received updated optimization input information to generate an updated optimized polymer production schedule. The updated optimized polymer production schedule may then be provided to the advanced process control, and the advanced process control may reschedule polymer production by the polymer production system in accordance with the updated optimized polymer production schedule. Thus, an updated optimized polymer production schedule may be generated as needed to maintain relevance with respect to changing conditions. In various embodiments, the update may be event driven, and/or time driven. In other words, in one embodiment, the updated optimization input information may be received in response to an event or condition, such as, for example, when changes in one or more data values exceed a threshold, when the input information includes a specified pattern or form, or when an executive order is received specifying an update. In another embodiment, the updated optimization input information may be received in response to time, i.e., the updates may occur periodically, e.g., monthly, bimonthly, weekly, daily, etc. In yet another embodiment, the updates may be performed in response to both events and time, as desired. The updates may be initiated manually or automatically, i.e., programmatically.

A more detailed embodiment of the method of FIG. 13 is described below with reference to FIG. 14.

FIG. 14—A More Detailed Method for Scheduling Polymer Production

FIG. 14 flowcharts a more detailed embodiment of the method of FIG. 13. As mentioned above, in various embodiments, some of the steps shown may be performed in a different order than shown, or may be omitted. Additional steps may also be performed. Where the steps in the method are substantially the same as corresponding steps in the method of FIG. 13, the descriptions may be abbreviated.

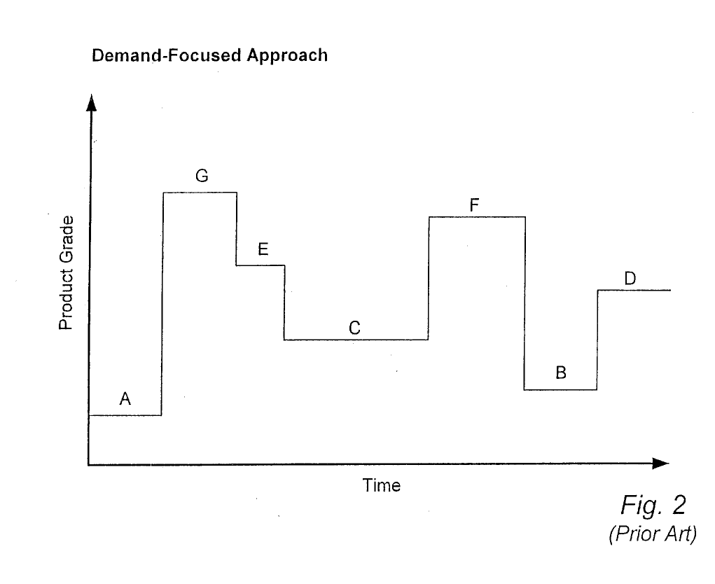

As FIG. 14 shows, in 1402, an initial schedule may be received or determined. The initial schedule may be used to seed the optimization process, and serves as a starting point for the method. The received initial schedule may be generated in a number of ways. For example, in one embodiment, the initial schedule may be a randomized schedule for current orders. In another embodiment, the initial schedule may be determined solely or primarily on the basis of order timing, as described above with reference to FIG. 2. In yet another embodiment, the initial schedule may be determined solely or primarily on the basis of transition timing or cost, as described above with reference to FIG. 3B. The initial schedule may include a plurality of schedule steps, where each step corresponds to a product or product grade. A sequence of one or more consecutive schedule steps may be referred to as a block of schedule steps, or simply a block.

In 1403, a determination may be made as to whether a feasible solution is possible. In other words, given the orders in the initial schedule, and any factors related to filling the orders, the method may determine whether it is possible to generate any feasible schedule solution at all. A feasibility check is an approximation for whether or not the given problem is feasible. For example, given a problem with N orders, a cost function, f(N) may be calculated. This function indicates whether or not the current schedule is violating any hard constraints by returning a very large number if any are. If the schedule violates one or more hard constraints (in this case missing due dates), the orders with high priority may be moved to the front of the schedule individually (one by one). After each movement, the feasibility of the schedule may be determined again. If all high priority orders are placed in front and one or more violations still exist, the high priority orders may be sorted by their due dates. The feasibility may be tested again. If no feasible schedule has been found at this point, the problem may be assumed to be infeasible. This provides only an approximation of the feasibility since a feasible solution may still exist even though the above algorithm may fail to find it. If no feasible solution is possible, then the method may terminate, as shown. Otherwise, the method may continue with 1404, below.

In 1404, input information may be received, such as, for example, the optimization input information described above in 1302 with reference to FIG. 13.

Then, in 1405, a search space may be determined for the initial schedule specifying a plurality of large scale permutations of the initial schedule. In one embodiment, a large scale permutation may include moving a block of one or more schedule steps from a current location, referred to as a source slot, to another location in the schedule, referred to as a destination slot. Such a move is referred to as a block insertion into the schedule. Thus, in one embodiment, there are three parameters which may define a given large scale permutation of the schedule: a block size, specifying the number of schedule steps in the block, the source slot, and the destination slot. In one embodiment, the block size may range from 1 to half the total number of steps in the schedule, N, i.e., N/2. The source slot may be limited by the block size. For example, large block sizes may restrict the selection of the first step in the block, i.e., the source slot, in that for a block size B, the source slot may be restricted to slot indices less than or equal to N-B. Similarly, the destination slot may be restricted in that only slots not included in the block may be considered as destinations for the block insertion.

The search space may be bounded by the allowable values of these three parameters. Thus, in one embodiment, determining the search space may include determining a range of block sizes, where each block size indicates a number of schedule steps comprised in the block of schedule steps; determining a range of source slots, where each source slot indicates a possible starting point for the block of one or more consecutive schedule steps; and determining a range of destination slots, where each destination slot indicates a possible insertion point for the block insertion. In one embodiment, the search space may be represented by three nested iteration loops corresponding to the three parameters, where the method may iterate through the allowed parameter values to search the space, as described in more detail below.

In 1406, acceptance criteria may optionally be determined for generated schedule solutions, referred to as local schedule solutions. In other words, criteria may be established that determine whether a particular schedule solution is accepted or rejected. It is noted that in other embodiments, the acceptance criteria may be determined at other points in the method. The acceptance criteria are described in more detail below in 1410.

In 1407, a large scale permutation of the initial schedule may be performed based on the determined search space, thereby generating an intermediate schedule. In one embodiment, performing a large scale permutation of the initial schedule may include performing a block insertion of schedule steps, where a block of one or more consecutive schedule steps is moved from a source slot to a destination slot in the initial schedule, thereby generating the intermediate schedule. This block insertion may be considered to be an implementation of the Large-Step Markov Chain Optimization approach described above with reference to FIG. 11. More specifically, the block insertion may serve as the ‘kick’, or large-step, in the algorithm. The new schedule resulting from the block insertion may comprise the intermediate schedule, which may then serve as the starting point for a local search, described below in 1408.

In response to the large scale permutation of 1407, a local search around the intermediate schedule may be performed to generate a local schedule solution, as indicated in 1408. In one embodiment, the local search may comprise a k-opt Lin-Kernighan search, as described above. In a preferred embodiment, the local search may comprise a 2-opt or a 3-opt Lin-Kernighan search, as is well known in the art. The local search may start with the intermediate schedule generated in 1407, and may perform one or more small permutations to locate a local minimum (in terms of schedule cost). The schedule corresponding to this local minimum comprises the local schedule solution.

Once the local schedule solution is determined in 1408, then in 1410, the acceptance criteria of 1406 may be applied to the local schedule solution to determine whether or not to accept the solution. In one embodiment, the acceptance criteria may be a probability. For example, in one embodiment, the probability may take the form:

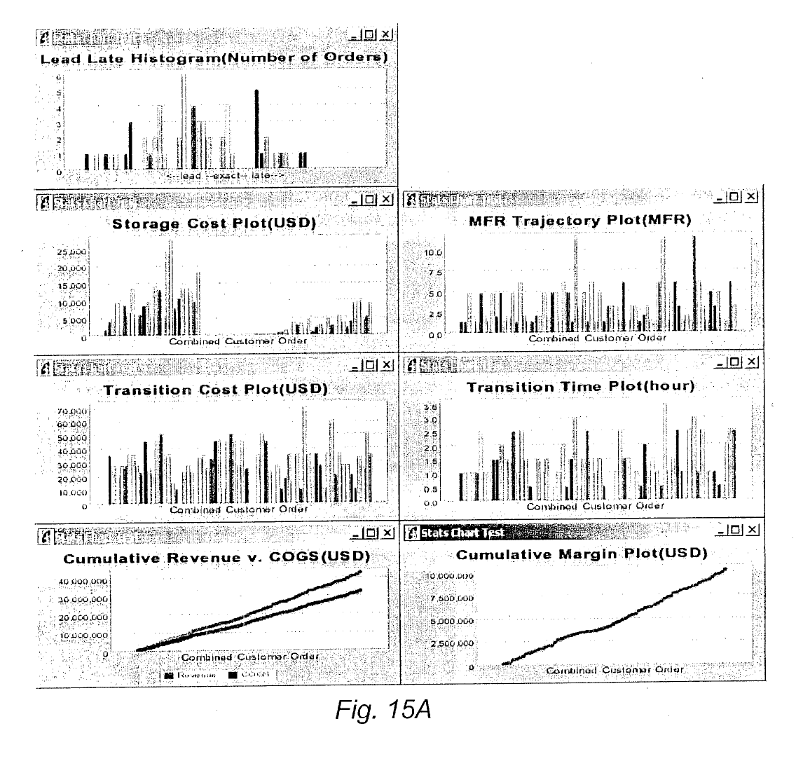

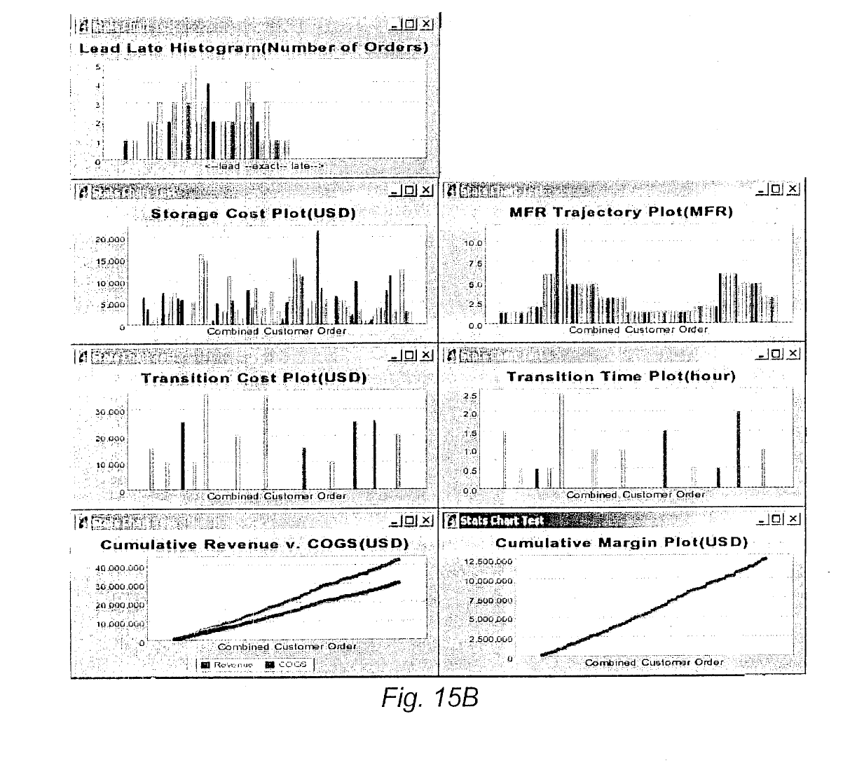

p=exp(−|C₂−C₁|/T) (1)

where C₂ and C₁ are cost metrics for respective schedules, e.g., the local schedule solution, and the initial schedule, and T is a parameter or function which decreases with time. The cost metrics may reflect costs in one or more terms, including, for example, monetary expense, time, opportunity costs, risk, missed orders, lateness, and/or any other metric useful in calculating a cost estimate for a schedule, as described in more detail below with reference to FIGS. 15A-15B. In one embodiment, T may be interpreted as a temperature which decreases with time, such as in simulated annealing, as is well known in the art. In another example, T may be a function of an iteration count in the method, where the iteration count represents a passage of time.

In one embodiment, the acceptance criteria may include different probability functions, depending on whether the local schedule solution is a better (lower cost) solution than the initial schedule. For example, if the local schedule solution is better than the initial schedule, the probability may be 1, such that any schedule improvement (over the initial schedule) may automatically be accepted, whereas if the local schedule is worse than the initial schedule, the probability may be a value less than 1, such as calculated with equation (1) above. Thus, the probability p may allow worse solutions to be considered to avoid getting stuck in an unsatisfactory local minimum. As described above, since the probability p decreases with time (or iterations), the likelihood of accepting a worse schedule may rapidly approach zero, leading to convergence on a particular solution, which may be substantially optimal for the scheduling problem. As mentioned above, in various embodiments, the acceptance criteria may be determined at other points in the method (than in 1406 above). For example, in one embodiment, the acceptance criteria for the local schedule solution may be determined prior to applying the acceptance criteria to the local schedule solution. In other embodiments, the acceptance criteria for the local schedule solution may be determined prior to, after, or during, any of the method steps described herein.

If the local schedule solution is accepted, then in 1412, a determination may be made as to whether the local schedule solution is the best solution found so far. If the local schedule solution is determined to be the best solution found so far, then the local schedule may be saved as the current best solution, as indicated in 1414.

After the local schedule solution is accepted, then in 1415, the initial schedule may be set to the local schedule solution. In other words, the local schedule solution may become the new initial schedule, and the method may return to 1405, and proceed as described above. Said another way, once the local schedule solution is accepted, the method may effectively restart with the local schedule solution as a new initial schedule, and a new search space may be determined based on the new initial schedule. The method may then continue as described above, with the new initial schedule as the starting point for a new large scale permutation.

Returning to step 1410, if the local schedule solution is not accepted (e.g., if the local schedule solution is worse than the initial schedule, and a draw against the probability of acceptance fails), then in 1416, ending conditions may be checked to determine whether to terminate the search process. For example, in one embodiment, where the search space is searched according to the three nested loops described above, the ending conditions may simply be that the loops have all reached their respective iteration limits, i.e., that the search space has been exhausted. In another embodiment, the ending conditions may include a maximum time and/or a maximum number of iterations specified such that if the total search time of the method or the number of iterations (large scale permutations) has been reach or exceeded, the search may terminate. In another embodiment, combinations of the above conditions, and/or any other conditions deemed appropriate may be included in the ending conditions.

If the ending conditions are not satisfied, then the method may proceed to step 1407, as shown, where a new large scale permutation of the initial schedule may be performed, as described above. In other words, a new ‘kick’ (e.g., a block insertion) may be performed on the initial schedule, generating a new intermediate schedule, followed by a local search, as described above. The particular large scale permutation may be determined by the loop iterations mention above, where the next block size, source slot, and/or destination slot, specifies the block insertion. Thus, the optimizer may iterate through at least a portion of each of the range of block sizes, the range of source slots, and the range of destination slots for each initial schedule, where each iteration corresponds to a large scale permutation of the initial schedule.

If, on the other hand, the ending conditions are satisfied in 1416, then in 1417, the best schedule solution may be output, and the method may terminate, as shown.

Thus, the method may iteratively perform successive large scale permutations with corresponding local searches to determine a substantially optimal polymer production schedule for use in analysis and/or for controlling a polymer production system.

FIGS. 15A-15B —Analyzing a Polymer Production Schedule

As mentioned above, each polymer production schedule may be evaluated or analyzed according to a cost metric which may be based on any of a variety of factors, to determine the acceptability of the schedule. In a more general sense, analysis of the performance and flexibility of a given schedule solution may be very important in determining optimal strategies for the production enterprise. In one embodiment, this analysis may be performed utilizing production and inventory management information. The metrics and tools for analyzing a given schedule described below and illustrated in FIGS. 15A-15B may facilitate evaluation of a given solution. More specifically, the visual displays presented in FIGS. 15A-15B may provide quick and intuitive feedback with respect to various aspects of the polymer production process and schedules which may aid substantially in managing the polymer production process.

FIG. 15A—Schedule Plots

In one embodiment, one or more plots of various metrics may be used to evaluate the performance and/or flexibility of various schedules, exemplary embodiments of which are presented in FIG. 15A.

Lateness Distribution

An optimal schedule solution meets (or attempts to meet) customer delivery date commitments at a profit. Ideally, manufacturing of each order is completed and immediately delivered to the customer on the appropriate due date. However, oftentimes this may not be possible due to the limited number of process lines and relative number of orders. Therefore, some orders may be manufactured early with a penalty of having to store the product, and some orders may be manufactured late with penalties for late delivery.

A detailed lateness distribution curve can provide insights into the quality of the schedule in terms of the uneven distribution of high peak deliveries near the due date and very limited late delivery. For example, as FIG. 15A shows, a lateness distribution histogram may visually provide information related to schedule lead/late times for a plurality of schedules. In one embodiment, the histogram may be generated by counting how many orders are 3 days late, 2 days late, 1 day late, exact, 1 day early (lead), 2 days early, and 3 days early, for example. The histogram may thus provide a visual tool for analyzing storage/inventory costs and late delivery penalties.

Key Cost Factors

A given schedule generally has a number of different cost factors associated with it, including, for example, manufacturing costs, inventory costs, transition costs, late delivery costs, energy costs, and raw-material costs, among others. The development of a schedule generally involves trading off these various costs to achieve a schedule with the lowest overall cost. However, understanding the individual costs for the schedule may also be important. These individual costs may be visualized by placing the plots of each cost together so that the tradeoffs among them can be observed, as shown in the plots of storage cost, transition cost, and transition time (where time may be considered to be a type of cost) of FIG. 15A. Any anomalies in the costs that might indicate a problem with the schedule may thus be seen clearly. For example, in a case where the objective function indicates a good schedule, there may still be a problem if costs for a certain category are too high. The user may then use this information to alter the parameters of the solution algorithm to achieve a schedule that meets the desired criteria. This may allow the user to impose subjective views on the quality of the schedule.

For example, if all of the costs other than the transition costs were omitted from the objective function, the resulting schedule should be the product cycle. The plots of the costs would show the costs that are incurred due to inventory costs and late delivery costs. Thus, the user could see the complete costs associated with the schedule instead of just the transition costs, which were used in the optimization.

Key Variable Phenomena and Characteristics

Most process industries have their own notion of measuring grade quality for the resulting processed material. In the case of the polymer industry, the primary metrics include MFR (Melt Flow Rate), MI (Melt Index), and density, etc. Rather than limiting displayed schedule information to what products are produced at what times, a plot of these primary metrics or measures over time for a given processing line may also be generated. An example of an MFR trajectory plot is shown in FIG. 15A. Plots of this type may allow the user to visualize the MFR or MI path that the process takes as the various different products are produced.

In the case of a productwheel schedule, this plot may show a ramp that moves from one product grade to another with minimal transition costs. Using other costs as part of the objective may produce a less uniform, i.e., more fluctuating, pattern. The user may then use this plot to observe the quality of the schedule and impose subjective criteria on its overall quality.

Economic Information

In one embodiment, one or more plots may visually display economic information related to one or more polymer production schedules. For example, as FIG. 15A also shows, plots of cumulative revenue and cumulative margin may provide economic and/or financial results for combined customer orders, which may then be used to analyze the relationship of various polymer production schedules and financial results in cumulative terms.

FIG. 15B—Metric Plots for Optimized Schedules

FIG. 15B illustrates the plots of FIG. 15A, but where the schedule has been optimized. As FIG. 15B shows, the plots are quite different. More specifically, there are much fewer transitions, leading to substantially lower transition costs. Overall storage costs have decreased, as well. Finally, the MFR trajectory plot is shown to have a much smoother profile than in the un-optimized case. Thus, the visual displays presented in FIGS. 15A and 15B may provide a useful tool for analyzing the performance and/or flexibility of polymer production schedules.

Although the system and method of the present invention has been described in connection with the preferred embodiment, it is not intended to be limited to the specific form set forth herein, but on the contrary, it is intended to cover such alternatives, modifications, and equivalents, as can be reasonably included within the spirit and scope of the invention as defined by the appended claims.

We claim:

1. A system for optimizing polymer production scheduling, the system comprising:
an input, operable to receive optimization input information;
a model of a polymer production system, wherein the model comprises one or more transition models representing transition behavior of the polymer production system;
an optimizer, operable to execute the model using the received optimization input information to generate an optimized polymer production schedule; and
an output, operable to output the generated optimized polymer production schedule, wherein the optimized polymer production schedule is usable to manage polymer production with a polymer production system.

2. The system of claim 1, wherein the optimization input information comprises one or more of:
economic information;
demand information;
demand forecast information;
customer order information;
customer book information;
customer priority information;
inventory information;
cost information;
production information;
product pricing information;
product book information;
product value information;
order value information;
line map information;
capacity limits;
scheduling horizon; and
ambient conditions.

3. The system of claim 2, wherein the cost information includes one or more of:
cost of manufacturing products;
cost of transitions between products;
cost of storing products prior to delivery; and
cost of missing demands.

4. The system of claim 2,
wherein the optimization input information comprises hypothetical scenario information; and
wherein the optimized polymer production schedule is usable to analyze business and production strategies based on the hypothetical scenario information.

5. The system of claim 1, wherein the optimization input information comprises one or more of:
an objective; and
one or more constraints;
wherein the optimizer is operable to use the objective and one or more constraints to generate the optimized polymer production schedule; and
wherein the optimized polymer production schedule attempts to meet the objective subject to the one or more constraints.

6. The system of claim 1, further comprising:
a controlled polymer production system, wherein the controlled polymer production system comprises:
a polymer production system; and
an advanced process control, coupled to the polymer production system, and operable to control operations of the polymer production system.

7. The system of claim 6, wherein the output is further operable to provide the optimized polymer production schedule to the advanced process control, and wherein the advanced process control is operable to schedule polymer production by the polymer production system in accordance with the optimized polymer production schedule.

8. The system of claim 7,
wherein the input is further operable to receive updated optimization input information;
wherein the optimizer is further operable to execute the model using the received updated optimization input information to generate an updated optimized polymer production schedule;
wherein the output is further operable to output the updated optimized polymer production schedule to the advanced process control; and
wherein the advanced process control is operable to re-schedule polymer production by the polymer production system in accordance with the updated optimized polymer production schedule.

9. The system of claim 8, wherein the input is operable to receive said updated optimization input information in response to one or both of:
an event; and
a time.

10. The system of claim 1, wherein the optimized polymer production schedule comprises one or more of:
grade levels to produce for one or more products;
quantities to produce of the one or more products;
when to produce each of the one or more products;
when to transition between the one or more products; and
which process line to use for each of the one or more products.

11. The system of claim 1, wherein the optimized polymer production schedule sequences manufacturing orders to maximize gross profit margin.

12. The system of claim 1, wherein said optimizer is operable to generate an optimized polymer production schedule by performing a Large-step Markov Chain Optimization Search in a space of possible schedules.

13. The system of claim 1, wherein said optimizer is operable to generate an optimized polymer production schedule by:
a) determining an initial schedule;
b) determining a search space for the initial schedule specifying a plurality of large-scale permutations of the initial schedule;
c) performing a large scale permutation of the initial schedule based on the search space to generate an intermediate schedule;
d) performing a local search around the intermediate schedule to generate a local schedule solution;
e) determining if the local schedule solution is accepted;
if the local schedule solution is accepted,
f) if the local schedule solution is better than a current best schedule, setting the current best schedule to the local schedule;
g) setting the initial schedule to the local schedule solution; and
h) returning to step b);
if the local schedule solution is not accepted,
i) determining if ending conditions are met; and
j) if ending conditions are not met, returning to step c); and
k) setting the optimized polymer production schedule to the current best schedule.

14. The system of claim 13, wherein said optimizer is further operable to generate an optimized polymer production schedule by:
determining acceptance criteria for the local schedule solution.

15. The system of claim 14, wherein said determining acceptance criteria for the local schedule solution is performed prior to e).

16. The system of claim 14, wherein said determining acceptance criteria for the local schedule solution is performed prior to b).

17. The system of claim 14, wherein said determining acceptance criteria for the local schedule solution comprises:
determining a probability of acceptance of the local schedule solution based on one or more of:
cost of the initial schedule;
cost of the local schedule solution; and
a time-dependent metric;

18. The system of claim 17, wherein said determining a probability of acceptance of the local schedule solution comprises using a simulated annealing approach to determine said probability.

19. The system of claim 13,
wherein said performing a large scale permutation of the initial schedule based on the search space to generate an intermediate schedule comprises:
performing a block insertion of schedule steps, wherein a block of one or more consecutive schedule steps are moved from a source slot to a destination slot in the initial schedule, thereby generating the intermediate schedule.

20. The system of claim 19, wherein said determining a search space for the initial schedule comprises:
determining a range of block sizes, wherein each block size indicates a number of schedule steps comprised in the block of schedule steps;
determining a range of source slots, wherein each source slot indicates a possible starting point for the block of one or more consecutive schedule steps; and
determining a range of destination slots, wherein each destination slot indicates a possible insertion point for the block insertion;
wherein said optimizer is operable to iterate through at least a portion of each of the range of block sizes, the range of source slots, and the range of destination slots for each initial schedule, and wherein each iteration corresponds to a large-scale permutation of the initial schedule.

21. The system of claim 13, wherein said performing a local search around the intermediate schedule to generate a local schedule solution comprises:
performing a Lin-Kernighan search around the intermediate schedule to generate the local schedule solution.

22. The system of claim 13, wherein said determining if ending conditions are met comprises one or more of:
determining if the search space for the initial schedule has been exhausted;
determining if a maximum number of iterations has been performed; and
determining if a maximum time period has elapsed.

23. The system of claim 13, wherein the initial schedule, the intermediate schedule, the local schedule solution, and the optimized polymer production schedule are each analyzable via one or more of:
lateness distribution;
key cost factors; and
key variable phenomena and characteristics.

24. The system of claim 1, wherein the model comprises one or more predictive models.

25. The system of claim 1, wherein the model comprises one or more of:
an analytic model;
an empirical model;
a rule-based model; and
a simulation.

26. The system of claim 1, wherein the model includes one or more of:
an objective; and
one or more constraints;
wherein the optimizer is operable to use the objective and one or more constraints to generate the optimized polymer production schedule; and
wherein the optimized polymer production schedule attempts to meet the objective subject to the one or more constraints.

27. The system of claim 1, wherein the model of the polymer production system comprises a model of a controlled polymer production system, wherein the model of the controlled polymer production system comprises:
a model of an advanced process control, operable to model control operations of the polymer production system.

28. A system for optimizing polymer production scheduling, the system comprising:
means for receiving optimization input information;
means for executing a model of a polymer production system using the received optimization input information to generate an optimized polymer production schedule, wherein the model includes one or more transition models representing transition behavior of the polymer production system; and
means for outputting the generated optimized polymer production schedule, wherein the optimized polymer production schedule is usable to manage polymer production with a polymer production system.

29. The system of claim 28, further comprising:
a controlled polymer production system, wherein the controlled polymer production system comprises:
a polymer production system; and
an advanced process control, coupled to the polymer production system, and operable to control operations of the polymer production system; and
means for providing the optimized polymer production schedule to the advanced process control, wherein the advanced process control is operable to schedule polymer production by the polymer production system in accordance with the optimized polymer production schedule.

30. The system of claim 29,
wherein said means for receiving optimization input information is further operable to receive updated optimization input information;
wherein said means for executing a model of a polymer production system is further operable to execute the model using the received updated optimization input information to generate an updated optimized polymer production schedule; and
wherein said means for outputting the generated optimized polymer production schedule is further operable to output the updated optimized polymer production schedule to the advanced process control; and
wherein the advanced process control is further operable to re-schedule polymer production by the polymer production system in accordance with the updated optimized polymer production schedule.

31. A method for optimizing polymer production scheduling, the method comprising:
receiving optimization input information;
an optimizer executing a model of a polymer production system using the received optimization input information to generate an optimized polymer production schedule, wherein the model includes one or more transition models representing transition behavior of the polymer production system; and
outputting the generated optimized polymer production schedule, wherein the optimized polymer production schedule is usable to manage polymer production with a polymer production system.

32. The method of claim 31, wherein the optimization input information comprises one or more of:
an objective; and
one or more constraints;
wherein said optimizer executing the model using the received optimization input information to generate an optimized polymer production schedule optimizer comprises:
the optimizer using the objective and one or more constraints to generate the optimized polymer production schedule; and
wherein the optimized polymer production schedule attempts to meet the objective subject to the one or more constraints.

33. The method of claim 31, further comprising:
providing the optimized polymer production schedule to an advanced process control;
the advanced process control scheduling polymer production by a polymer production system in accordance with the optimized polymer production schedule.

34. The method of claim 33, further comprising:
receiving updated optimization input information;
the optimizer executing the model using the received updated optimization input information to generate an updated optimized polymer production schedule;
outputting the updated optimized polymer production schedule to the advanced process control; and
the advanced process control re-scheduling polymer production by the polymer production system in accordance with the updated optimized polymer production schedule.

35. The method of claim 31, wherein said optimizer executing the model using the received optimization input information to generate an optimized polymer production schedule comprises:
performing a Large-step Markov Chain Optimization Search in a space of possible schedules.

36. The method of claim 31, wherein said optimizer executing the model using the received optimization input information to generate an optimized polymer production schedule comprises:
a) determining an initial schedule;
b) determining a search space for the initial schedule specifying a plurality of large-scale permutations of the initial schedule;
c) performing a large scale permutation of the initial schedule based on the search space to generate an intermediate schedule;
d) performing a local search around the intermediate schedule to generate a local schedule solution;
e) determining if the local schedule solution is accepted;
if the local schedule solution is accepted,
f) if the local schedule solution is better than a current best schedule, setting the current best schedule to the local schedule;
g) setting the initial schedule to the local schedule solution; and
h) returning to step b);
if the local schedule solution is not accepted,
i) determining if ending conditions are met; and
j) if ending conditions are not met, returning to step c); and
k) setting the optimized polymer production schedule to the current best schedule.

37. A carrier medium which stores program instructions which are executable to perform:
receiving optimization input information;
executing a model of a polymer production system using the received optimization input information to generate an optimized polymer production schedule, wherein the model includes one or more transition models representing transition behavior of the polymer production system; and
outputting the generated optimized polymer production schedule, wherein the optimized polymer production schedule is usable to manage polymer production with a polymer production system.

38. The carrier medium of claim 37,
wherein the optimization input information comprises hypothetical scenario information; and
wherein the optimized polymer production schedule is usable to analyze business and production strategies based on the hypothetical scenario information.

39. The carrier medium of claim 37, wherein said optimizer executing the model using the received optimization input information to generate an optimized polymer production schedule comprises:
performing a Large-step Markov Chain Optimization Search in a space of possible schedules.

40. The carrier medium of claim 46, wherein said optimizer executing the model using the received optimization input information to generate an optimized polymer production schedule comprises:
a) determining an initial schedule;
b) determining a search space for the initial schedule specifying a plurality of large-scale permutations of the initial schedule;
c) performing a large scale permutation of the initial schedule based on the search space to generate an intermediate schedule;
d) performing a local search around the intermediate schedule to generate a local schedule solution;
e) determining if the local schedule solution is accepted;
if the local schedule solution is accepted,
f) if the local schedule solution is better than a current best schedule, setting the current best schedule to the local schedule;
g) setting the initial schedule to the local schedule solution; and
h) returning to step b);
if the local schedule solution is not accepted,
i) determining if ending conditions are met; and
j) if ending conditions are not met, returning to step c); and
k) setting the optimized polymer production schedule to the current best schedule.
